(19) United States
(12) Patent Application Publication
(10) Pub. No.: US 2024/0042393 A1
(43) Pub. Date: Feb. 8, 2024

(54) METHODS OF MODIFICATION OF ION EXCHANGE MEMBRANES

(71) Applicant: GVD Corporation, Cambridge, MA (US)

(72) Inventors: Christopher M. Thompson, Cambridge, MA (US); W. Shannan O'Shaughnessy, Cambridge, MA (US)

(21) Appl. No.: 18/361,667

(22) Filed: Jul. 28, 2023

Related U.S. Application Data
(60) Provisional application No. 63/393,606, filed on Jul. 29, 2022.

(51) Int. Cl. B01D 67/00; B01D 61/42; B01D 69/02; B01J 41/14; B01J 39/20

(52) U.S. Cl. CPC B01D 67/00933; B01D 61/422; B01D 69/02; B01J 41/14; B01J 39/20; B01D 67/00931; B01D 2325/42; B01D 2325/26; B01D 2325/14; B01D 2325/18; B01D 2323/30; B01D 2325/16

(57) ABSTRACT

Methods of modifying ion exchange membranes are described herein. Such modified ion exchange membranes can be used in, for example, desalination processes.

### CROSS-REFERENCE TO RELATED APPLICATIONS

This application claims the benefit of and priority to U.S. Provisional Application No. 63/393,606 filed Jul. 29, 2022, which is hereby incorporated herein by reference in its entirety.

### FIELD OF THE INVENTION

Methods for modifying and improving properties of ion exchange membranes, using chemical vapor deposition processes, are generally provided herein.

### BACKGROUND OF THE INVENTION

Membrane-based electro-driven desalination methods are attractive alternatives to reverse osmosis (RO) and thermal processes which make up the majority of existing desalination capacity. The most mature electro-driven process, electrodialysis (ED), offers benefits including include low costs, high energy efficiency, low plant footprints and minimal feed pretreatment requirements.

Despite the significant advantages, the high cost and poor selectivity and susceptibility to scaling (i.e. fouling) of ion exchange membranes (IEMs) are obstacles to the wider use of ED. Commercial IEMs for electrodialysis currently cost between $85 and $300/m² making up a significant fraction (>60%) of ED system costs (He, W., et al., System-Level Cost and Performance Optimization for Electrodialysis Reversal Desalination. (2018); Hand, S., et al., Technoeconomic Analysis of Brackish Water Capacitive Deionization: Navigating Tradeoffs between Performance, Lifetime, and Material Costs. Environ. Sci. Technol. 53, 13353-13363 (2019)). IEM costs comprise ˜55%-76% of levelized cost of water (LCOW) for low and moderate salinity (<30,000 ppm TDS) applications where energy inputs are comparatively low (Hand, S., et al., Technoeconomic Analysis of Brackish Water Capacitive Deionization: Navigating Tradeoffs between Performance, Lifetime, and Material Costs. Environ. Sci. Technol. 53, 13353-13363 (2019)). In high salinity applications(>30,000 ppm TDS) inorganic scaling of the IEM by salts of multivalent ions lowers efficiency and shortens membrane life. If the issues with membrane cost, membrane selectivity and scaling could be addressed, it would lead to greater opportunity to capitalize on the potential of ED and other similar processes.

In addition to cost and conductivity, membrane selectivity improvements can significantly increase the economic potential of ED. Some types of selectivity that are desirable are selectivity based on ion charge, size or valence (charge magnitude). In many cases, it is difficult to achieve high conductivity and selectivity in a single material. Various methods of applying thin layers have been explored, e.g. the so-called “layer-by-layer” method, but these are often imprecise or prohibitive for manufacturing. The layer-by-layer approach involves 5-20 sequential dipping steps are required with a total process time of 6 minutes each (Rijnaarts, T. et al., Layer-by-layer coatings on ion exchange membranes: Effect of multilayer charge and hydration on monovalent ion selectivities. J. Memb. Sci. 570-571,513-521 (2019); Sahin, S., et al., Modification of cation-exchange membranes with polyelectrolyte multilayers to tune ion selectivity in capacitive deionization. ACS Appl. Mater. Interfaces 12, 34746-34754 (2020)). From standpoints of manufacturability and performance it would be useful to use a top-treatment method that could apply a high charge density layer with good thickness control in a single step (Femmer, R., et al., Ion transport through electrolyte/polyelectrolyte multilayers. Sci. Rep. 5,1-12 (2015)).

IEMs that have monovalent selectivity (selectivity based on ion valence) have better resistance to inorganic scaling in ED applications (Andreeva, M. A., et al., Influence of surface modification of mk-40 membrane with polyaniline on scale formation under electrodialysis. Membranes (Basel). 10,1-14 (2020); Andreeva, M. Impact of surface properties of cation-exchange membranes on the formation of Ca2+ and Mg2+ containing scales during electrodialysis of their aqueous solutions (2018)). In high salinity applications, sparingly soluble salts of divalent ions, such as Mg(OH)₂ or Ca(OH)₂ may precipitate at the surface of the membrane. Scaling increases membrane resistance and is an important cause of reduced average process efficiency and reduced membrane lifetime (McGovern, R. K. et al. On the cost of electrodialysis for the desalination of high salinity feeds. Appl. Energy 136, 649-661 (2014); Andreeva, M. A., et al., Influence of surface modification of mk-40 membrane with polyaniline on scale formation under electrodialysis. Membranes (Basel). 10, 1-14 (2020); Andreeva, M. Impact of surface properties of cation-exchange membranes on the formation of Ca2+ and Mg2+ containing scales during electrodialysis of their aqueous solutions (2018)).

Selective IEMs also enable the separation and concentration of valuable minerals that may be sold to offset the costs of water treatment. There are many applications where ED could be used to desalinate water while simultaneously producing a valuable commodity. At the current cost of desalination, it is reported that ten elements (rubidium, iodine, lithium, boron, bromide, potassium, magnesium sodium, calcium and strontium) could be economically extracted from seawater, given their concentration and market value (Loganathan, P., et al., Mining valuable minerals from seawater: A critical review. Environ. Sci. Water Res. Technol. 3, 37-53 (2017)). Another example of ED-enabled mineral recycling is the re-use of greenhouse or agricultural water.

Accordingly, improved methods for modifying ion exchange membranes that address the aforementioned issues and manufacturing limitations in known IEMs are needed.

Therefore, it is an object of the present invention to provide novel methods for modifying and improving the properties of ion exchange membranes.

### SUMMARY OF THE INVENTION

Described herein are selectivity modified ion exchange membranes and methods of manufacturing thereof. In one instance, a method of modifying an existing ion exchange membranes involves depositing a selectivity modifying layer on an ion exchange membrane by the steps of:
(1) placing the ion exchange membrane into a reactor chamber;
(2) flowing a precursor gas in proximity to the ion exchange membrane, wherein the precursor gas comprises at least one monomer; and
(3) depositing the selectivity modifying layer on one or more surfaces of the ion exchange membrane by chemical vapor deposition (CVD) to form a selectivity modified ion exchange membrane,
wherein the selectivity modifying layer is optionally formed of or comprises an ion-conductive polymer.

Also described herein are modified ion exchange membranes and methods of manufacturing thereof. For such membranes, these are modified without formation of any additional polymer layers (i.e., selectivity modifying layers or other layers) on any layers already present on an existing ion exchange membrane. In one non-limiting instance, a method of modifying one or more properties of an ion exchange membrane includes the steps of:
(1′) placing the ion exchange membrane into a reactor chamber; and
(2′) exposing the ion exchange membrane to one or more conditions of a chemical vapor deposition (CVD) without deposition or formation of any additional layer(s) on the ion exchange membrane,
wherein the ion exchange membrane after step (2′) forms a modified ion exchange membrane.

In certain instances, the chemical vapor deposition process used in the above methods can be an initiated chemical vapor deposition (iCVD) or plasma-enhanced chemical vapor deposition (PECVD). Such vapor-based approaches have the benefit of being solvent-free.

The selectivity modified ion exchange membranes and modified ion exchange membranes described herein can be used in various applications. For example, they can be used in desalination methods, such as electrodialysis and capacitive deionization. Other desalination processes, such as ion concentration polarization may utilize selectivity modified ion exchange membranes.

The selectivity modified ion exchange membranes described herein can also be used for acid recovery or salt recovery by diffusion dialysis. Furthermore, selectivity modified ion exchange membranes have applications in fuel cells (hydrogen or methanol fuel cells), electrolyzers (such as hydrogen or CO₂ electrolyzer), batteries (such as lithium ion batteries) and redox flow batteries.

### BRIEF DESCRIPTION OF THE DRAWINGS

FIG. 1 shows a graph of the vinylpyridine (VP) to divinylbenzene (DVB) (VP:DVB ratio, y-axis) of an iCVD deposited film as a function of the ratio of VP:DVB flow rates (x-axis) in the precursor stream.

FIG. 2 shows FT-IR spectra of two quaternized (in-situ and ex-situ) poly(divinylbenzene-co-vinylpyridine) copolymers and an unquaternized poly(divinylbenzene-co-vinylpyridine) copolymer.

FIG. 3A shows a graph of the AC impedance (ohm-cm²; y-axis) of various quaternized poly(divinylbenzene-co-pyridine) deposited at different vinylpyridine (VP) to divinylbenzene (DVB) (VP:DVB ratios; x-axis) by iCVD.

FIG. 3B shows a graph of the salt diffusion (mol/cm²/s); y-axis) of various quaternized poly(divinylbenzene-co-pyridine) deposited at different vinylpyridine (VP) to divinylbenzene (DVB) (VP:DVB ratios; x-axis) by iCVD.

FIG. 4 shows FT-IR spectra of low, moderate, and highly sulfonated poly(styrene) polymers.

FIG. 5 shows a graph of the extent of sulfonation (y-axis) as a function of excess chlorosulfonic acid (CSA) flow (sccm; x-axis).

FIG. 6 shows a graph of the monovalent selectivity (Na/Ca; y-axis) versus current density (A/m²; x-axis) of commercial cation exchange membranes with and without an iCVD modification to provide a copolymer having a positively charged backbone thereon.

FIG. 7 shows a graph of the monovalent selectivity (Na/Ca; y-axis) of a membrane modified with an iCVD deposited copolymer layer thereon having a thickness of between 0 and 48 nm (x-axis).

FIG. 8A shows a bar graph of the monovalent selectivity (Na/Ca; y-axis) of a Fumasep FKS membrane (left bar) and an iCVD modified Fumasep FKS membrane (right bar) at 7500 and 35000 ppm concentrations.

FIG. 8B shows a bar graph of the monovalent selectivity (Na/Mg; y-axis) of a Fumasep FKS membrane and an iCVD modified Fumasep FKS membrane.

### DETAILED DESCRIPTION

Various methods of modifying ion exchange membranes are described herein.

I. Definitions

For convenience, certain terms employed in the specification, examples, and appended claims are listed here.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

The term “reacting,” as used herein, refers to the forming of a bond between two or more components to produce a stable, isolable compound. For example, a first component and a second component may react to form one reaction product comprising the first component and the second component joined by a covalent bond. That is, the term “reacting” does not refer to the interaction of solvents, catalysts, bases, ligands, or other materials which may serve to promote the occurrence of the reaction with the component(s).

The term “reactive species”, as used herein, refers to one or more species which can be generated in the gas phase from a component, such as a monomer, present in a precursor gas and which upon polymerization can form a polymer. The term “reactive species” includes monomers and/or oligomers. The reactive species disclosed herein may be gaseous at room temperature and atmospheric pressure. Alternatively, the reactive species are liquids or solids at room temperature and atmospheric pressure, for example, they may be evaporated at reduced pressure or heated or both in order to perform the methods described herein.

“Inert Gas” or “Inert Atmosphere,” are used interchangeably herein and refer to a gas or mixture of gases which are not reactive under reaction conditions within a vacuum chamber.

“Fluoropolymer coating” and “Fluorocarbon polymer coating,” are used interchangeably herein and refer to a vapor deposited polymer coating, where the polymer contains polymeric chains formed of CF₂ repeat units.

“Vacuum” as used herein refers to a vacuum by removing gaseous components and/or gases from a reactor chamber to a pressure which falls below atmospheric pressure.

“Temperature-controlled support”, as used herein, refers to means of retaining and positioning an article, such as a porous support, within a reactor chamber during coating and which can heat, cool, or both the porous support in contact with the temperature-controlled support.

As used herein in the specification and in the claims, numerical ranges disclosed include, but are not limited to, ranges of temperatures, ranges of pressures, ranges of integers, ranges of force values, ranges of times, ranges of thicknesses, and ranges of gas flow rates. The disclosed ranges of any type, disclose individually each possible number that such a range could reasonably encompass, as well as any sub-ranges and combinations of sub-ranges encompassed therein. For example, disclosure of a temperature range is intended to disclose individually every possible temperature value that such a range could encompass, consistent with the disclosure herein. Numerical ranges disclosed are inclusive of the end points of the range unless specified otherwise.

Use of the term “about” is intended to describe values either above or below the stated value, which the term “about” modifies, in a range of approx. +/−10%; in other instances the values may range in value either above or below the stated value in a range of approx. +/−5%. When the term “about” is used before a range of numbers (i.e., about 1-5) or before a series of numbers (i.e., about 1, 2, 3, 4, etc.) it is intended to modify both ends of the range of numbers and/or each of the numbers recited in the entire series, unless specified otherwise.

II. Selectivity Modified Ion Exchange Membranes and Methods of Manufacturing Thereof

Described herein are selectivity modified ion exchange membranes and methods of manufacturing thereof. Ion exchange membranes can transport cations or anions under an electrical or chemical potential. Ion exchange membranes can have either negatively or positively charged groups attached to a polymeric material making up the membrane. The counterion of each is a transferable ion. For instance, a cation exchange membrane will have fixed negative charges and mobile positively charged cations. Similarly, an anion exchange membrane will have fixed positively charged groups and mobile negatively charged anions. Ion exchange membrane properties are controlled by the amount, type and distribution of these fixed ionic groups.

In one instance, a method of modifying an existing ion exchange membranes involves depositing a selectivity modifying layer on an ion exchange membrane by the steps of:
(1) placing the ion exchange membrane into a reactor chamber;
(2) flowing a precursor gas in proximity to the ion exchange membrane, wherein the precursor gas comprises at least one monomer; and
(3) depositing the selectivity modifying layer on one or more surfaces of the ion exchange membrane by chemical vapor deposition (CVD) to form a selectivity modified ion exchange membrane,
wherein the selectivity modifying layer is optionally formed of or comprises an ion-conductive polymer.

In certain instances, the chemical vapor deposition process used in the above method is an initiated chemical vapor deposition (iCVD) or plasma-enhanced chemical vapor deposition (PECVD). Details for iCVD and PECVD processes and conditions used are described in detail below. Such vapor-based approaches have the benefit of being solvent-free.

The selectivity modifying layer (SML) can be deposited atop a pre-existing ion exchange membrane thereby forming a two-layer composite.

A. Ion Exchange Membranes

In general, the ion exchange membrane used in the methods may be obtained from commercial manufacturers or may be fabricated using art known methods. In some instances, commercially available ion exchange membranes include a porous support which can be made, without limitation, from a suitable polymeric material which can be or includes poly(ethersulfone), polypropylene, polyethylene, porous oxides, nylon, polyamide, cellulose, polyvinylidene fluoride, alumina, titania, zirconia or silicon carbide, or any suitable combinations thereof. Such porous supports can have a thickness ranging from about 1 to about 10 mm or about 5 to about 200 microns. Commercially available ion exchange membranes include one or more ion-conductive layers thereon of any suitable thickness and may be classified as cation exchange membranes or anion exchange membranes. In some instances, the ion exchange membranes can be made from non-fluorinated polymer(s) or fluorinated polymer(s). In still some other instances, the ion exchange membrane can be a freestanding membrane without the presence of any porous or other support present therein.

In some instances, the ion exchange membrane is selected to be a cation exchange membrane and the selectivity modifying layer deposited thereon forms an ion-conductive polymer that includes cation or anion groups thereon. In some other instances, the ion exchange membrane is selected to be an anion exchange membrane and the selectivity modifying layer deposited thereon forms an ion-conductive polymer that includes anion or cation groups. In still some other instances, the ion exchange membrane is a cation exchange membrane or an anion exchange membrane and the selectivity modifying layer deposited thereon is uncharged.

In certain instances, the porous supports present in the commercial ion exchange membranes, without particular limitation, can have a porosity which is greater than about 40%, 50%, 60%, or 70%. In certain instances, the porous support includes a plurality of pores having an average diameter of about 0.05 microns to about 10 microns, about 0.1 microns to about 1 microns, or about 450 nm to about 2 microns.

The selectivity modifying layer formed in step (3) is deposited onto the ion exchange membrane with the intention of creating a thin film of ion-conductive polymer thereon and over any existing ion-conductive layer(s) already forming part of the ion exchange membrane. The selectivity modifying layer, deposited by CVD, can provide improved properties, such as ion conductivity and selectivity, as described in more detail below.

In some instances, the ion exchange membrane can be temperature controlled during the method, such as during step (3), to a temperature ranging from between about −30° C. to about 150° C. Such temperature control can be used to tune the properties of the deposited selectivity modifying layer and/or the deposition rate thereof during step (3).

In some instances, it is believed that the exposure of the ion exchange membrane to the conditions of chemical vapor deposition, such as radical forming conditions, can cause the support to become chemically activated which can result in increased adhesion of polymer films or coatings deposited thereon. In some instances, it may be necessary to treat the ion exchange membrane to maximize adhesion. This can involve pre-treating the surface of the Ion exchange membrane prior to step (3). The pretreatment can be carried out inside the deposition chamber as part of the process or as a separate step. It may also be desirable to tune the selectivity modifying layer composition as a function of distance from the ion exchange membrane to produce a gradient of chemo-mechanical properties (such as swelling).

In some instances, the methods described can be carried out in a continuous or semi-continuous roll-to-roll mode, wherein the ion exchange membrane is in the form of a rolled sheet which can be loaded into the reactor chamber and rolled optionally over a temperature controlled plate during the depositing step.

B. Monomers and Selectivity modifying Layer formed Thereof

The methods involve flowing a precursor gas which includes at least one monomer. In some instances, the at least one monomer is selected from divinylbenzene, styrene, styrene sulfonic acids, styrene sulfonates, methacrylic acid, vinyl pyridine, vinylamine, and vinylpyridinium salts. In some instances, the at least one monomer forms a selectivity modifying layer which is an ion-conductive polymer directly from the monomer selected when the monomer includes a polymerizable group (such as a vinyl group) and an ionizable component that can form or bears a charged group on interaction with a solvent. The type of ionizable or charged group may include, but is not limited to, amines, quaternary ammonium groups, sulfonic acids, phosphonic acids, and/or carboxylic acids. They may also include complex ions of transition metals.

It is understood that under appropriate chemical vapor deposition conditions, such monomer(s) are able to form reactive species, which are polymerizable, and polymerize on one or more surfaces of the ion exchange membrane. In other words, precursor monomer molecules can decompose into the reactive species and migrate to the surfaces of the ion exchange membrane, where they polymerize into a polymer forming the selectivity modifying layer on the ion exchange membrane. Such chemical vapor deposition processes include a chemical activation source selected from a heating filament, a continuous or pulsed radiofrequency or microwave plasma, or ultraviolet light to cause formation of reactive species from the decomposition or activation of monomer(s) present in the precursor gas.

In some cases, the precursor gas may further include at least one spacer monomer which can be selected, for example, from the group consisting of styrene, methylmethacrylate, methacrylic acid, acrylic acid, and methylacrylate. In some cases, the precursor gas includes at least one crosslinking monomer which can be selected, for example, from the group consisting of divinylbenzene and alkyldimethacrylates, and trimethyltrivinyl-cyclotrisiloxane.

For any combination of spacer monomers, crosslinker monomers, and monomers which contain or are converted to contain ionic components, the selectivity modifying layer deposited may have a range of mole fractions of each monomer thereof, as may be present. In some instances, the amount of crosslinker would be between about 1 and about 95% or between about 15 and about 60%. The amount of monomers which contain or are converted to contain ionic component could range from about 1 to about 95% or between and 80%. The amount of spacer monomer could range from about 0 to about 95%. The composition of the polymer can be controlled by changing the ratio of such precursor monomers in the gas phase, or changing the reactor chamber pressure, and/or porous support temperature.

In some instances of the methods described, a chemical conversion may need to be carried out during depositing step (3) on the at least one monomer before depositing and forming the selectivity modifying layer. For chemical conversion during deposition step (3), it is understood that this involves the inclusion of an additional reagent in the gas precursor flow that reacts with either the monomer or the polymer, where this takes place after the monomer has been volatilized and before the deposition process is complete. Such a chemical conversion can be a sulfonation, methylation, phosphorylation, oxidation or reduction of a monomer during the depositing step. For example, in the case where a desired ionic component is not volatile enough to formed directly from a selected monomer during the deposition process in the gas phase it may be necessary to carry out a conversion of other volatile monomers into the desired ionic component in parallel and concurrently with the deposition process. As one non-limiting example, styrene sulfonic acid may be formed by flowing styrene monomer and a sulfonating agent (e.g., chlorosulfonic acid, sulfur trioxide etc.) through the reactor chamber. This results in the deposition of an ion-conductive polymer containing poly(styrene sulfonic acid). In yet another example, volatile monomer conversion can be the quaternization of an amine-containing monomer, such as vinylpyridine, using an alkylhalide, such as methyl iodide. The result would be a vinylpyridinium monomer, vinyl pyridine and a methylating agent (methyl iodide, methyl bromide, etc.) may be co-flowed (in a chamber) to give a polymer containing N-methyl vinylpyridinium iodide. In some cases, the quaternization process may be carried out for at least between about 1 hour and 24 hours, as well as any sub-ranges or individual values disclosed within. In some instances, water vapor may be added during co-flowing to accelerate the quaternization process, such as by including a reservoir of water in the chamber during the process. Methods of evaluating and quantifying the extent of quaternization are known in the art. In one instance, the extent of quaternization may be evaluated using Fourier transform infrared spectroscopy. In some instances, the partial pressure of a methylating agent (methyl iodide, methyl bromide, etc.) can be between 2000 mTorr and 10,000 mTorr, as well as any sub-ranges or individual values disclosed within. In some other instances, the partial pressure of a methylating agent (methyl iodide, methyl bromide, etc.) can be about 2000 mTorr.

In still other instances, such a chemical conversion can be carried out on the selectivity modifying layer that has already been deposited and formed on the ion exchange membrane during the depositing step, as opposed to the monomer species prior to polymerization. For chemical conversion after deposition (i.e., a subsequent step), the chemical conversion is understood to occur after the polymer has been deposited to form the selectivity modifying layer. In such instances, the polymer can be exposed to a reactive agent, as discussed below, which would convert it to a final form. It is possible that both conversion of volatile monomers and deposited polymers can occur during the depositing step. As an example, a growing selectivity modifying layer (i.e., polymer film) can be reacted with a vapor phase agent or component in order to convert it into an ion conductive polymer material during the depositing step. For example, sulfonation of a deposited polystyrene polymer by exposure to a vapor-phase sulfonating agent (e.g. chlorosulfonic acid or sulfur trioxide) may be used. The sulfonation can be carried out simultaneously with the polymerization or it can be performed in a subsequent step, after completion of the deposition, by introducing the sulfonating agent for an amount of time necessary to achieve the conversion. Methods of evaluating and quantifying the extent of sulfonation are known in the art. In one instance, the extent of sulfonation may be evaluated using Fourier transform infrared spectroscopy. In still another example, quaternization of an amine-containing polymer by exposure to a vapor phase alkylhalide, such as methyl iodide, can be used.

In instances where the chemical conversion is performed in a subsequent step, following completion of the deposition, the deposited selectivity modifying layer may be post-processed to induce ionic functionality by contacting the layer with, for example, a liquid reagent outside of the reactor chamber. This can involve contacting the deposited polymer with fuming sulfuric acid, sulfuric acid, or chlorosulfonic acid to induce sulfonation. In still another example, it can involve contacting the deposited polymer of an amine-containing polymer with liquid alkylhalide, such as methyliodide.

For such chemical conversions, as described above, the pressure of the vapor phase reagent (i.e., sulfonating or alkylating agent, etc.) may range between about 1 mTorr and 760 Torr, as well as suitable sub-ranges within. The reaction or residence times necessary to achieve the chemical conversions by exposure to agents in the gas or liquid phase may vary as needed, but preferably are between about 5 seconds and about 60 minutes. The reaction or residence time of the reactants can be set to achieve a desired yield of sulfonation, methylation, phosphorylation, oxidation or reduction. Conditions for achieving sulfonation, methylation, phosphorylation, oxidation or reduction are known in the art. In such cases, the relative amounts of, for example, sulfonating or alkylating agent, to monomer (such as styrene or vinylpyridine) or deposited polymer (such as polystyrene or poly(vinylpyridine) may be tuned to be roughly stoichiometric, or may be chosen to be at an excess of sulfonating or alkylating agent or an excess of monomer.

In the methods described, the monomers preferentially form a deposited selectivity modifying layer which can be ion-conductive or can be converted into an ion-conductive polymer. In some instances, the selectivity modifying layer may be uncharged. The selectivity modifying layer is typically a film or coating on all or substantially all of the one or more surfaces of the ion exchange membrane. In such instances, the polymer substantially encompasses or covers substantially all of the surface area (e.g., greater than about 99%, about 99.5%, about 99.8%, about 99.9%, about 99.99%, or 100%) of the ion exchange modified by the selectivity modifying layer. In certain preferred instances, the film or coating is preferably free of defects, such as pinholes. Methods of visualizing the surface of the film or coating to determine the presence or absence of pinholes or other defects are known in the art, such as by electron microscopy techniques.

In some instances, the deposited selectivity modifying layer has a thickness of between about 50 nm and about 20,000 nm or 450 and 4,000 nm. In some instances, the selectivity modifying layer is ultrathin and has a thickness of between about 5 and about 100 nm, about 5 and about 50 nm, or about 5 and 25 nm. In some cases, the thickness ranges from between about 1 and about 2000 nm. In some instances, the deposited selectivity modifying layer is of uniform in thickness over the entirety of the film or coating present on the selectivity modified ion exchange membrane.

In other cases, the thickness of the selectivity modifying layer may not necessarily have uniform thickness. The thickness of the film may be determined by determining the thickness of the film at a plurality of areas (e.g., at least 2, at least 4, at least 6, at least 10, at least 20, at least 40, at least at least 100, or more areas) and calculating the average thickness. Where thickness of a film is determined via probing at a plurality of areas, the areas may be selected so as not to specifically represent areas of more or less polymer present based upon a pattern. In some embodiments, the difference in thickness between the thickest part of the film and the thinnest part of the film may be relatively small. For instance, the difference in thickness between the thickest part of the film and the thinnest part of the film may be less than or equal to 25% of the average film thickness, less than or equal to 10% of the average film thickness, less than or equal to 5% of the average film thickness, less than or equal to 2% of the average film thickness, or less than or equal to 1% of the average film thickness.

One of ordinary skill in the art is aware of methods for determining the thickness of a selectivity modifying layer deposited. In one approach, a witness coupon (i.e., a substrate comprising a smooth surface such as a silicon wafer or a glass wafer) is placed in the deposition chamber during substrate coating. Subsequent to deposition, a scratch is made on the witness coupon down to the bare substrate and the thickness of the coating measured using a contact profilometer. In other instances, thickness can be determined by use of XPS (x-ray photoelectron spectroscopy) depth profiling, where the thickness of the selectivity modifying layer is determined from the time it takes for a slow etching process to remove the layer.

In some instances, thinner coatings of the selectivity modifying layer can provide better conductivity while thicker coatings would provide better mechanical stability. Whichever of these properties is more important can be used to select the desired thickness of a polymer layer deposited onto the ion exchange membrane. Moreover, the selected thickness can be chosen to be high enough to impart a desired selectivity, but low enough to avoid adding significant resistance to the resultant selectivity modified ion exchange membrane.

For the methods described herein, the deposited selectivity modifying layer formed on the ion exchange membrane is covalently crosslinked during step (3). The degree of crosslinking can range from about 1% to about 90% or about 5% to about 60%. In some instances, the degree of crosslinking is at least about 20%, 30%, 40%, 50%, 60%, 70%, 80%, or 90% to create low-swelling polymer selectivity modified ion exchange membranes with high selectivity (e.g. monovalent selectivity) and/or high mechanical stability.

C. Selectivity Modified Ion Exchange Membrane Properties

The methods described allow for the deposition of a selectivity modifying layer of suitable thicknesses on an ion exchange membrane. Such a layer can be used to modify and improve one or more properties of an existing ion exchange membrane, such as to increase conductivity, permselectivity, monovalent selectivity, anti-fouling properties, and stability or durability, as compared to the ion exchange membrane before the selectivity modifying layer was added. In some instances, stability or durability can be evaluated by wear rates of the membranes under flow, likelihood of being punctured by an object (such as a metal whisker), or by determining the rate of oxidation of the membrane in the presence of oxidizing species. In some instances, antifouling can be evaluated by determining the rate of accumulation of a biofilm or the rate of accumulation of organic matter or rate of inorganic scaling on the membrane.

In some instances, the selectivity modified ion exchange membrane formed has an ionic conductivity of between about 0.01 S/cm² to about 100 S/cm² or between about 1 S/cm² to about 100 S/cm². The ion conductivity can be targeted for a cation exchange membrane and may be that of cations including but not limited to sodium, hydrogen, lithium, calcium, potassium, nickel, iron, vanadium. The ion conductivity can be targeted for an anion exchange membrane and may be that of anions including but not limited to chloride, fluoride, bromide, iodide, sulfate, phosphate, nitrate, hydroxide. In addition, any group of ions may be targeted for high conductivity and any group of ions may be targeted for exclusion.

In some instances, the selectivity modified ion exchange membrane formed can have a permselectivity (charge sign selectivity) of greater than about approximately 80%, 85%, or 90%. In some instances, the permselectivity is greater than about 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.99%, or 99.999%. The permselectivity can be quantified, for example, using the rate of salt diffusion driven by a concentration gradient across the membrane under no electrical field. In some instances, the rate of salt diffusion (mol/cm²/s) is measured as the rate of salt diffusion of sodium ions (from NaCl) across an ion exchange membrane with a concentration gradient of 0.1 M. Other metal ions, such as Ca and Mg may be used from salt solutions thereof. In some instances, the rate of salt diffusion (mol/cm²/s) for the ion exchange membranes described herein may be in a range of between about 1×10⁻⁸ to about 1×10⁻¹¹ mol/cm²/s, as well as any sub-ranges or individual values disclosed within. The skilled person is familiar with methods and conditions for measuring rates of salt diffusion in ion exchange membranes.

In some instances, the ion exchange membrane formed have an AC impedance value of between about 0.1 to about 500 ohm-cm², as well as any sub-ranges or individual values disclosed within. The AC impedance value of an ion exchange membrane, as described herein, can be measured at 10 kHz in a suitable electrolyte solution, such as 1M Na₂SO₄. The skilled person is familiar with methods and conditions for measuring AC impedance values of ion exchange membranes.

In some instances, the application of a thin (5-20 nm) selectivity modifying layer can provide a highly selective layer to the surface of an existing ion exchange membrane in order to increase its selectivity. For instance, the selectivity modified ion exchange membranes can be made to provide monovalent selectivity (selectivity based on ion valence) which can provide better resistance to inorganic scaling in electrodialysis applications (Andreeva, M. A., et al., Influence of surface modification of mk-40 membrane with polyaniline on scale formation under electrodialysis. Membranes (Basel). 10, 1-14 (2020); Andreeva, M. Impact of surface properties of cation-exchange membranes on the formation of Ca²⁺ and Mg²⁺ containing scales during electrodialysis of their aqueous solutions (2018)). In high salinity applications, sparingly soluble salts of divalent ions, such as Mg(OH)₂ or Ca(OH)₂, may precipitate at the surface of an ion exchange membrane. Inorganic scaling increases membrane resistance and is an important cause of reduced average process efficiency and reduced membrane lifetime (McGovern, R. K. et al., On the cost of electrodialysis for the desalination of high salinity feeds. Appl. Energy 136, 649-661 (2014); Andreeva, M. A., et al., Influence of surface modification of mk-40 membrane with polyaniline on scale formation under electrodialysis. Membranes (Basel). 10, 1-14 (2020); Andreeva, M. Impact of surface properties of cation-exchange membranes on the formation of Ca2+ and Mg2+ containing scales during electrodialysis of their aqueous solutions (2018)). Monovalent selectivity refers to the ability to separate monovalent species from polyvalent species. This can include rejecting calcium or magnesium ions while allowing permeation of sodium ions. In some instances, it can also include rejecting phosphate or sulfate ions while allowing permeation of chloride ions. In still other instances, this can also include selectivity toward or against transition metal ions, like iron or zinc relative to sodium or protons.

In certain instances, the selectivity modified ion exchange membranes prepared according to the above methods have proton blocking selectivity. Proton blocking selectivity refers to the ability of the membrane to slow the permeation of protons through anion exchange membranes, while allowing continued conductivity of anions. In still other instances, the selectivity modified ion exchange membranes prepared according to the above methods exhibit selectivity. Size selectivity refers to selective conductivity based on the ionic radius or the hydrated ionic radius. In some instances, the selectivity modified ion exchange membranes can separate out any two ions that have a hydrated radius difference of about 0.2 nm and have radii of between about 3.2 and 4.6 nm. For example, separation of 3.2 vs. 3.4 nm or 4.4 vs 4.6 nm could be achieved. In some instances, separation is also possible based on ionic radius (non-hydrated), where ionic radii can vary from between about 59 picometers and about 170 picometers, and it is possible to separate ions with differences in ionic radius of at least about 20 picometers.

The choice of the composition of the selectivity modifying layer will depend on the type of selectivity desired for the resulting ion exchange membrane. If desired selectivity is based on valence, the selectivity modifying layer may have the opposite charge as the underlying pre-existing ion exchange membrane. If selectivity based on size is desired, the amount of crosslinking in the selectivity modifying layer may be set at a high value (i.e., greater than 60%).

The selectivity modified ion exchange membranes prepared according to the above methods can demonstrate improved selectivity as ion exchange membranes which can also enable the separation and concentration of valuable minerals that may be sold to offset the costs of water treatment. There are various applications where electrodialysis could be used to desalinate water, while simultaneously producing a valuable commodity. At the current cost of desalination, it is reported that ten elements (rubidium, iodine, lithium, boron, bromide, potassium, magnesium sodium, calcium and strontium) could be economically extracted from seawater, given their concentration and market value (Loganathan, P., et al., Mining valuable minerals from seawater: A critical review. Environ. Sci. Water Res. Technol. 3, 37-53 (2017)).

In some instances, for the selectivity modified ion exchange membranes prepared according to the above methods the presence of the selectivity modifying layer can slow the transport of a solvent, such as water, acetonitrile, propylene carbonate, or organic alcohols, through the membrane.

III. Modified Ion Exchange Membranes and Methods of Manufacturing Thereof

Also described herein are modified ion exchange membranes and methods of manufacturing thereof, where the membranes are modified without formation of any additional polymer layers (i.e., selectivity modifying layers or other layers) on any layers already present on an existing ion exchange membrane. In one non-limiting instance, a method of modifying one or more properties of an ion exchange membrane includes the steps of:
(1′) placing the ion exchange membrane into a reactor chamber; and
(2′) exposing the ion exchange membrane to one or more conditions of a chemical vapor deposition (CVD) without deposition or formation of any additional layer(s) on the ion exchange membrane,
wherein the ion exchange membrane after step (2′) forms a modified ion exchange membrane.

In certain instances, the one or more conditions of the chemical vapor deposition process used in the above method are those of an initiated chemical vapor deposition (iCVD) or plasma-enhanced chemical vapor deposition (PECVD). Details for iCVD and PECVD processes and conditions used are described in detail below. Such vapor-based approaches have the benefit of being solvent-free. It is further understood that the conditions of such chemical vapor deposition processes (iCVD or PECVD) exclude the presence or use of any monomers or reactive species which would form any polymers or layers on the ion exchange membrane.

In some instances, the one or more conditions to which the ion exchange membrane is exposed to are selected from:
(a) Exposure to vacuum between about 10 mTorr and about 10 Torr, as well as any individual values or any sub-ranges disclosed therein. In some instances, the rate of depressurization may be between about 1 Torr per minute to about 1000 Torr per minute, as well as individual values or any sub-ranges disclosed therein;
(b) Re-pressurization, such as at a rate of about 1 Torr per minute to about 1000 Torr per minute, as well as individual values or any sub-ranges disclosed therein;
(c) Exposure to chemical conversion conditions, such as sulfonating or methylating reagents (i.e., sulfur trioxide or methyliodide) at pressures of about 10 mTorr to about 10 Torr for times of about 5 seconds to about 60 minutes, as well as individual values or any sub-ranges disclosed therein;
(d) Exposure to heat from a filament that may bring the temperature of the surface of the ion exchange membrane to temperatures of between about 30° C. and about 150° C., as well as individual values or any sub-ranges disclosed therein;
(e) Exposure to radio-frequency (RF) plasma at powers of about 5 W to about 300 W for periods of time between about 1 second and about 10 minutes, as well as individual values or any sub-ranges disclosed therein; and/or
(f) Exposure to radical species, generated from initiators, such as tert-butoxide radical, at pressures of about 10 mTorr to about 10 Torr for periods of about 5 seconds to about 60 minutes.
   For (a)-(f), it is understood that pressures, powers, and times described above are non-limiting and others may be used as described elsewhere in the instant disclosure.

For (c) above, the chemical conversion conditions can include use of a vapor phase reagent where the pressure of the vapor phase reagent (i.e., sulfonating or alkylating agent, etc.) may range between about 1 mTorr and 760 Torr, as well as suitable sub-ranges within. The reaction or residence times necessary to achieve the chemical conversions by exposure to agents in the gas or liquid phase may vary as needed, but preferably are between about seconds and about 60 minutes. The reaction or residence time of the reactants can be set to achieve a desired yield of sulfonation, methylation, phosphorylation, oxidation, or reduction. Conditions for achieving sulfonation, methylation, phosphorylation, oxidation or reduction are known in the art.

The above conditions, (a)-(f), in any single or combined application to the ion exchange membrane during step (2′), are able to modify properties of the ion exchange membrane so as to increase conductivity, permselectivity, anti-fouling properties, and stability or durability, as compared to the ion exchange membrane before exposure to these conditions.

A. Ion Exchange Membranes

In general, the ion exchange membrane used in the methods may be obtained from commercial manufacturers or may be fabricated using art known methods. In some instances, commercially available ion exchange membranes include a porous support which can be made, without limitation, from a suitable polymeric material which can be or includes poly(ethersulfone), polypropylene, polyethylene, porous oxides, nylon, polyamide, cellulose, polyvinylidene fluoride, alumina, titania, zirconia or silicon carbide, or any suitable combinations thereof. Such porous supports can have a thickness ranging from about 1 to about 10 mm or about 5 to about 200 microns. Commercially available ion exchange membranes include one or more ion-conductive layers thereon of any suitable thickness and may be classified as cation exchange membranes or anion exchange membranes. In some instances, the ion exchange membranes can be made from non-fluorinated polymer(s) or fluorinated polymer(s).

In certain instances, the porous supports present in the commercial ion exchange membranes, without particular limitation, can have a porosity which is greater than about 40%, 50%, 60%, or 70%. In certain instances, the porous support includes a plurality of pores having an average diameter of about 0.05 microns to about 10 microns, about 0.1 microns to about 1 microns, or about 450 nm to about 2 microns.

In some instances, the ion exchange membrane can be temperature controlled during the method, such as during step (2′), to a temperature ranging from between about −30° C. to about 150° C.

In some instances, the methods described can be carried out in a continuous or semi-continuous roll-to-roll mode, wherein the ion exchange membrane is in the form of a rolled sheet which can be loaded into the reactor chamber and rolled optionally over a temperature controlled plate during step (2′).

B. Modified Ion Exchange Membrane Properties

The methods described allow for the modification of one or more properties of an ion exchange membrane by exposure to conditions of chemical vapor deposition but without the formation of any layers or polymers thereon. Such modification can increase conductivity, permselectivity, monovalent selectivity, anti-fouling properties, and stability or durability, as compared to the ion exchange membrane before the exposure to the conditions of step (2′). In some instances, stability or durability can be evaluated by wear rates of the membranes under flow, likelihood of being punctured by an object (such as a metal whisker), or by determining the rate of oxidation of the membrane in the presence of oxidizing species. In some instances, antifouling can be evaluated by determining the rate of accumulation of a biofilm or the rate of accumulation of organic matter or rate of inorganic scaling on the membrane.

In some instances, the modified ion exchange membrane formed can have a resistivity of less than about 1 ohm-cm² or less than about 0.5 ohm-cm². In some cases, the modified ion exchange membrane formed has an ionic conductivity of between about 0.01 S/cm² to about 100 S/cm² or between about 1 S/cm² to about 100 S/cm². The ion conductivity can be targeted for a cation exchange membrane and may be that of cations including but not limited to sodium, hydrogen, lithium, calcium, potassium, nickel, iron, vanadium. The ion conductivity can be targeted for an anion exchange membrane and may be that of anions including but not limited to chloride, fluoride, bromide, iodide, sulfate, phosphate, nitrate, hydroxide. In addition, any group of ions may be targeted for high conductivity and any group of ions may be targeted for exclusion.

In some instances, the modified ion exchange membrane formed can have a permselectivity (charge sign selectivity) of greater than about approximately 80%, 85%, or 90%. In some instances, the permselectivity is greater than about 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, 99.99%, or 99.999%. The permselectivity can be quantified, for example, using the rate of salt diffusion driven by a concentration gradient across the membrane under no electrical field or by comparing the relative ion transference number of the various ions.

In some instances, exposing the ion exchange membrane to CVD conditions can provide a modified ion exchange membrane with increased selectivity. For instance, the modified ion exchange membranes can be made to provide monovalent selectivity (selectivity based on ion valence) which can provide better resistance to inorganic scaling in electrodialysis applications (Andreeva, M. A., et al., Influence of surface modification of mk-40 membrane with polyaniline on scale formation under electrodialysis. Membranes (Basel). 10, 1-14 (2020); Andreeva, M. Impact of surface properties of cation-exchange membranes on the formation of Ca2+ and Mg2+ containing scales during electrodialysis of their aqueous solutions (2018)). In high salinity applications, sparingly soluble salts of divalent ions, such as Mg(OH) 2 or Ca(OH)₂, may precipitate at the surface of an ion exchange membrane. Inorganic scaling increases membrane resistance and is an important cause of reduced average process efficiency and reduced membrane lifetime (McGovern, R. K. et al., On the cost of electrodialysis for the desalination of high salinity feeds. Appl. Energy 136, 649-661 (2014); Andreeva, M. A., et al., Influence of surface modification of mk-40 membrane with polyaniline on scale formation under electrodialysis. Membranes (Basel). 10, 1-14 (2020); Andreeva, M. Impact of surface properties of cation-exchange membranes on the formation of Ca2+ and Mg2+ containing scales during electrodialysis of their aqueous solutions (2018)). Monovalent selectivity refers to the ability to separate monovalent species from polyvalent species. This can include rejecting calcium or magnesium ions while allowing permeation of sodium ions. In some instances, it can also include rejecting phosphate or sulfate ions while allowing permeation of chloride ions. In still other instances, this can also include selectivity toward or against transition metal ions, like iron or zinc relative to sodium or protons.

In certain instances, the modified ion exchange membranes prepared according to the above methods have proton blocking selectivity. Proton blocking selectivity refers to the ability of the membrane to slow the permeation of protons through anion exchange membranes, while allowing continued conductivity of anions. In still other instances, the modified ion exchange membranes prepared according to the above methods exhibit selectivity. Size selectivity refers to selective conductivity based on the ionic radius or the hydrated ionic radius. In some instances, the modified ion exchange membranes can separate out any two ions that have a hydrated radius difference of about 0.2 nm and have radii of between about 3.2 and 4.6 nm. For example, separation of 3.2 vs. 3.4 nm or 4.4 vs 4.6 nm could be achieved. In some instances, separation is also possible based on ionic radius (non-hydrated), where ionic radii can vary from between about 59 picometers and about 170 picometers, and it is possible to separate ions with differences in ionic radius of at least about 20 picometers.

The modified ion exchange membranes prepared according to the above methods can demonstrate improved selectivity as ion exchange membranes which can also enable the separation and concentration of valuable minerals that may be sold to offset the costs of water treatment. There are various applications where electrodialysis could be used to desalinate water, while simultaneously producing a valuable commodity. At the current cost of desalination, it is reported that ten elements (rubidium, iodine, lithium, boron, bromide, potassium, magnesium sodium, calcium and strontium) could be economically extracted from seawater, given their concentration and market value (Loganathan, P., et al., Mining valuable minerals from seawater: A critical review. Environ. Sci. Water Res. Technol. 3, 37-53 (2017)).

IV. Chemical Vapor Deposition Methods

The deposition of a selectivity modifying layer described in the methods above are achieved by chemical vapor deposition (CVD) methods to afford selectivity modified ion exchange membranes. In other instances, modification of one or more properties of an existing ion exchange membrane, without deposition of any new layers thereon, can also be achieved by exposure to chemical vapor deposition (CVD) conditions. In the latter instances, where no additional layers are formed the methods exclude the presence of monomers or other reactive species which could otherwise form polymers. Such CVD methods and conditions can more particularly be related to initiated chemical vapor deposition methods or plasma enhanced vapor deposition methods.

Gases which are not reactive under the deposition conditions can impact the properties of a deposited polymer, such as selectivity modifying layer, when present. Accordingly, in certain methods where a selectivity modifying layer is deposited, it may be desirable to dilute the reactive gases, such as monomer gases, used to form the polymer with one or more inert gasses. Flow of inert gas may also be utilized to isolate the reactive gas from direct contact with an energy source (such as the filament). This may allow for activation of the precursor gas while preventing undesirable side reaction(s) due to too much energy input or catalytic effects. In some embodiments, one type of inert gas, two types of inert gases, three types of inert gases, or more, may be present during polymerization. Non-limiting examples of inert gases include nitrogen, helium, and argon. The inert gases may comprise any suitable percentage of the total pressure during polymerization. Total pressure during polymerization may be defined as the sum of the partial pressures of the monomer(s), initiator(s), and inert gas(es) which may be present during polymerization. In some embodiments, the inert gas(es) comprise greater than or equal to 50% of the total pressure, greater than or equal to 60% of the total pressure, greater than or equal to 70% of the total pressure, greater than or equal to 80% of the total pressure, greater than or equal to 90% of the total pressure, or greater than or equal to 95% of the total pressure. According to certain embodiments, the inert gas(es) comprise less than or equal to 98% of the total pressure, less than or equal to 95% of the total pressure, less than or equal to 90% of the total pressure, less than or equal to 80% of the total pressure, less than or equal to 70% of the total pressure, or less than or equal to 60% of the total pressure. Combinations of the above-referenced ranges are also possible (e.g., greater than or equal to 50% of the total pressure and less than or equal to 90% of the total pressure, greater than or equal to 70% of the total pressure and less than or equal to 90% of the total pressure, or greater than or equal to 80% of the total pressure and less than or equal to 90% of the total pressure). Other ranges are also possible.

Polymerization may occur under conditions comprising one or more monomers at any suitable partial pressure. In some instances, the chemical vapor deposition is carried out at gas pressures from about 10 mTorr to about mTorr or about 500 mTorr to about 4,000 mTorr. In some other instances, any of the one or more monomer may be at a partial pressure of less than or equal to 2000 mTorr, 1750 mTorr, 1500 mTorr, 1250 mTorr, 1000 mTorr, 900 mTorr, 800 mTorr, 700 mTorr, 600 mTorr, 500 mTorr, 400 mTorr, 300 mTorr, 200 mTorr, 100 mTorr, 75 mTorr, less than or equal to 50 mTorr, less than or equal to 30 mTorr, less than or equal to 20 mTorr, less than or equal to 15 mTorr, less than or equal to 10 mTorr, less than or equal to 5 mTorr, or less than or equal to 3 mTorr. In some embodiments, the partial pressure is less than 50 mTorr. In some embodiments, the partial pressure is about 5 mTorr. According to certain embodiments, any of the one or more monomers may be at a partial pressure of greater than or equal to 1 mTorr, greater than or equal to 5 mTorr, greater than or equal to 10 mTorr, or greater than or equal to 20 mTorr. Combinations of the above-referenced ranges are also possible (e.g., greater than or equal to 3 mTorr and less than or equal to 50 mTorr, greater than or equal to 1 mTorr and less than or equal to 50 mTorr, greater than or equal to 1 mTorr and less than or equal to 20 mTorr, greater than or equal to 3 mTorr and less than or equal to 10 mTorr). Other ranges are also possible.

In certain embodiments, the polymerization of monomers may be initiated by one or more initiators. In some instances, one or more initiators may be used in the absence of monomers, when the method avoids formation of any polymer or layers thereof on the ion exchange membrane, In some embodiments, initiator(s) may comprise one or more groups which are capable of generating free radicals under the experimental conditions. In accordance with some embodiments, such free radicals may be capable of reacting with monomers to form growing polymer chains. According to certain embodiments, initiators may be capable of decomposing to form one or more molecules comprising a free radical. In certain embodiments, initiators may comprise functional groups which are capable of forming radicals under the experimental conditions (e.g., by decomposing). Non-limiting examples of suitable functional groups include peroxide groups, persulfate groups, and azo groups. In some embodiments, the initiator may comprise one or more of tert-butyl peroxide and tert-amyl peroxide. The initiator(s) may be present at any suitable partial pressure. In some embodiments, the initiator(s) may be at a partial pressure of less than or equal to 300 mTorr, 200 mTorr, 100 mTorr, 75 mTorr, less than or equal to 50 mTorr, less than or equal to 30 mTorr, less than or equal to 20 mTorr, less than or equal to 15 mTorr, less than or equal to 10 mTorr, less than or equal to 5 mTorr, or less than or equal to 3 mTorr. According to certain embodiments, the initiator(s) may be at a partial pressure of greater than or equal to 1 mTorr, greater than or equal to 5 mTorr, greater than or equal to mTorr, or greater than or equal to 20 mTorr. In some embodiments, the partial pressure of the monomer is less than about 75 mTorr. In some embodiments, the partial pressure of the initiator is about 7.5 mTorr. Combinations of the above-referenced ranges are also possible (e.g., greater than or equal to 1 mTorr and less than or equal to 75 mTorr, or greater than or equal to 1 mTorr and less than or equal to 50 mTorr, greater than or equal to 1 mTorr and less than or equal to 20 mTorr, greater than or equal to 1 mTorr and less than or equal to 10 mTorr, greater than or equal to 5 mTorr and less than or equal to 10 mTorr). Other ranges are also possible.

The one or more monomers and initiator(s), as may be present, may be provided in any suitable ratio. In some embodiments, the ratio may be based on the partial pressures of the monomer(s) to the initiator. The ratio of the partial pressure of the initiator(s) to the partial pressure of the monomers, defined as the partial pressure of the initiators divided by the partial pressure of the monomers, may be any suitable value. In accordance with certain embodiments, the ratio of the partial pressure of the initiators to the partial pressure of the monomers may be greater than or equal to 0.1, greater than or equal to 0.2, greater than or equal to 0.5, greater than or equal to 0.8, greater than or equal to 1, greater than or equal to 2, greater than or equal to 5, or greater than or equal to 8. In some embodiments, the ratio of the partial pressure of the initiators to the partial pressure of the monomers may be less than or equal to 10, less than or equal to 8, less than or equal to 5, less than or equal to 2, less than or equal to 1, less than or equal to 0.8, less than or equal to 0.5, or less than or equal to 0.2. Combinations of the above-referenced ranges are also possible (e.g., greater than or equal to 0.1 and less than or equal to 10). Other ranges are also possible.

The one or more monomers, as may be present, may be provided in any suitable ratio between the respective monomers. In some embodiments, the ratio may be based on the partial pressures of the monomer(s) present. In some embodiments when two monomers are present, the ratio of the partial pressure of a first monomer to the partial pressure of as second monomer, defined as the partial pressure of a first monomer divided by the partial pressure of a second monomer, may be any suitable value. In accordance with certain embodiments, the ratio of the partial pressure of the first monomer to the partial pressure of the second monomer may be greater than or equal to 0.1, greater than or equal to 0.2, greater than or equal to 0.5, greater than or equal to 0.8, greater than or equal to 1, greater than or equal to 2, greater than or equal to 5, or greater than or equal to 8, or greater than or equal to 10. In some embodiments, the ratio of the partial pressure of the first monomer to the partial pressure of the second monomer may be less than or equal to 10, less than or equal to 8, less than or equal to 5, less than or equal to 2, less than or equal to 1, less than or equal to 0.8, less than or equal to 0.5, less than or equal to 0.2, or less than or equal to 0.1. Combinations of the above-referenced ranges are also possible (e.g., greater than or equal to 0.1 and less than or equal to 10). Other ranges are also possible.

In certain embodiments, the total pressure of all of the species (e.g., monomer(s), initiator(s), inert gas(es)) which may be present during the methods described fall within a specified range. In some embodiments, the total pressure of all species present is greater than or equal to 10 mTorr, greater than or equal to 25 mTorr, greater than or equal to 50 mTorr, greater than or equal to 75 mTorr, greater than or equal to 100 mTorr, greater than or equal to 200 mTorr, greater than or equal to 200 mTorr, greater than or equal to 300 mTorr, greater than or equal to 400 mTorr, greater than or equal to 500 mTorr, greater than or equal to 750 mTorr, greater than or equal to 1000 mTorr, or greater than or equal to 2500 mTorr, greater than or equal to 5000 mTorr, greater than or equal to 10000 mTorr. According to certain embodiments, the total pressure of all species present is less than or equal to 5000 mTorr, less than or equal to 2500 mTorr, less than or equal to1000 mTorr, less than or equal to 750 mTorr, less than or equal to 500 mTorr, less than or equal to 400 mTorr, less than or equal to 300 mTorr, less than or equal to 200 mTorr, less than or equal to 100 mTorr, less than or equal to 75 mTorr, less than or equal to 50 mTorr, or less than or equal to 25 mTorr. Combinations of the above-referenced ranges are also possible (e.g., greater than or equal to 50 mTorr and less than or equal to 5000 mTorr, greater than or equal to 50 mTorr and less than or equal to 300 mTorr, greater than or equal to 50 mTorr and less than or equal to 200 mTorr, greater than or equal to 75 mTorr and less than or equal to 200 mTorr, or greater than or equal to mTorr and less than or equal to 100 mTorr). In some embodiments, total pressure of all of the species may be in a range of between about 1000 to about 3500 mTorr or about 1200 to about 3200 mTorr; as well as sub-ranges or individual values therein. In some other embodiments, the total pressure of all species present during polymerization may be atmospheric pressure. Other ranges are also possible.

According to certain embodiments, the one or more monomer(s), initiator(s), and/or inert gas(se) which may be present may flow into the reaction chamber. In some embodiments, these species will then either flow out of the reaction chamber or may polymerize to form a polymer on a substrate, such as an ion exchange membrane if a selectivity modifying layer is to be deposited thereon. The residence time of a species may be defined as the total amount of time that that species spends in the reaction chamber prior to either flowing out or undergoing polymerization. The residence times for the monomer(s), initiator(s), and inert gas(es) may be any suitable value. In some embodiments, each of the one or more monomer(s), initiator(s) and inert gas(es) may independently have a residence time of greater than or equal to 5 seconds, greater than or equal to 10 seconds, greater than or equal to 15 seconds, greater than or equal to 30 seconds, greater than or equal to 45 seconds, greater than or equal to 60 seconds, greater than or equal to 90 seconds, greater than or equal to 120 seconds, or greater than or equal to 180 seconds. In some embodiments, each of the one or more monomer(s), initiator(s) and inert gas(es) may independently have a residence time of greater than or equal to 1 minute, greater than or equal to 5 minutes, greater than or equal to 10 minutes, greater than or equal to 15 minutes, greater than or equal to 20 minutes, greater than or equal to 25 minutes, greater than or equal to 30 minutes, greater than or equal to 35 minutes, greater than or equal to 40 minutes, greater than or equal to 45 minutes, greater than or equal to 55 minutes, or greater than or equal to 60 minutes. According to certain embodiments, each of the one or more monomer(s), initiator(s) and inert gas(es) has a residence time of less than or equal to 300 seconds, less than or equal to 180 seconds, less than or equal to 120 seconds, less than or equal to 90 seconds, less than or equal to 60 seconds, less than or equal to 45 seconds, less than or equal to 30 seconds, less than or equal to 15 seconds, or less than or equal to 10 seconds. Combinations of the above-referenced ranges are also possible (e.g., greater than or equal to 15 seconds and less than or equal to 90 seconds). Other ranges are also possible. In some embodiments, the residence time of all of the species is substantially similar. In accordance with some embodiments, a method for synthesizing a polymer may comprise one or more deposition cycles.

According to certain embodiments, polymer deposition may include forming a polymer, which forms selectivity modifying layer on a substrate, such as an ion exchange membrane, at any suitable rate. In some instances, the selectivity modifying layer is deposited at a rate of between about 0.1 nm/min to about 100 nm/min or between about 10 nm/min to about 50 nm/min. In some embodiments, the rate may be greater than or equal to 0.01 nm/min, greater than or equal to 0.025 nm/min, greater than or equal to 0.05 nm/min, greater than or equal to 0.1 nm/min, greater than or equal to 0.25 nm/min, greater than or equal to 0.5 nm/min, greater than or equal to 1 nm/min, greater than or equal to 2.5 nm/min, greater than or equal to 5 nm/min, greater than or equal to 10 nm/min, greater than or equal to 25 nm/min, or greater than or equal to 50 nm/min. In some other embodiments, the rate may be greater than or equal to 10 nm/min, greater than or equal to 25 nm/min, greater than or equal to 50 nm/min, greater than or equal to 75 nm/min, greater than or equal to 100 nm/min, greater than or equal to 250 nm/min, greater than or equal to 500 nm/min, greater than or equal to 750 nm/min, greater than or equal to 1000 nm/min, greater than or equal to 1250 nm/min, greater than or equal to 1500 nm/min, greater than or equal to 1750 nm/min, or greater than or equal to 2000 nm/min. In accordance with certain embodiments, the rate may be less than or equal to 100 nm/min, less than or equal to 50 nm/min, less than or equal to 25 nm/min, less than or equal to 10 nm/min, less than or equal to 5 nm/min, less than or equal to 2.5 nm/min, less than or equal to 1 nm/min, less than or equal to 0.5 nm/min, less than or equal to 0.25 nm/min, less than or equal to 0.1 nm/min, less than or equal to 0.05 nm/min, or less than or equal to 0.025 nm/min Combinations of the above-referenced ranges are also possible (e.g., greater than or equal to 0.025 nm/min and less than or equal to 1 nm/min). Other ranges are also possible.

According to certain embodiments, the one or more monomer(s), initiator(s), sulfonating or alkylating agent (if present), and/or inert gas(se) which may be present may flow into the reaction chamber at a total gas flow rate from about 0.1 to about 20 sccm or about 1 to about 10 sccm, as well as sub-ranges or individual values therein. In some embodiments, the one or more monomer(s), initiator(s), sulfonating or alkylating agent(s), and/or inert gas(es) which may be present each have a flow into the reaction chamber at gas flow rates from about 0.1 to about 20 sccm, about 0.1 to about 15 sccm, about 0.1 to about 10 sccm, about 0.1 to about 5 sccm, about 0.1 to about 3 sccm, or about 0.1 to about 1 sccm; as well as sub-ranges or individual values therein.

In some instances, the flow rate of sulfonating agent can be set to be greater than that of a monomer or monomers to provide a sulfonated polymer where the extent of sulfonation is approximately linearly dependent on the excess flow of sulfonating agent, relative to monomer(s).

A. Initiated Chemical Vapor Deposition (iCVD)

In some instances of the methods described, the selectivity modifying layer is deposited onto the ion exchange membrane using an initiated chemical vapor deposition (iCVD). In some other instances of the methods described, the properties of an ion exchange membrane are modified by exposure to conditions of an initiated chemical vapor deposition (iCVD), where the conditions do not cause formation or deposition of any polymers or layers thereof (i.e., by exclusion of monomers or other reactive species which could form such polymers or layers during the exposure conditions). The skilled person would be able to exclude monomers from the iCVD conditions described below.

Initiated CVD (iCVD) is a variation of hot filament chemical vapor deposition and is a one-step, solvent-free process. The iCVD mechanism closely resembles free radical polymerization and preserves the organic functional groups of the reactant. In iCVD, a gas or mixture of monomer gases is introduced into a reactor chamber under mild vacuum in the vicinity of an array of heated filament wires.

The low operating pressures of an iCVD process, typically range from about 10-100 Pa (75-10000 mTorr), and allow formation of polymer, typically as a conformal coating, on a substrate (i.e., porous support, silicon wafer, porous polymer support (e.g. PES), electrode, or another ion exchange membrane). “Conformal”, as used herein, generally means that that the features of the substrate having polymer deposited thereon, such as angles, scale, etc. are preserved.

iCVD reactants and appropriate reactor designs can be chosen such that selective chemical pathways are followed under conditions of low filament temperature and low energy input (5-400 Watts). No electrical excitation of the gas is required, and polymer deposition/growth proceeds via conventional polymerization pathways.

In an iCVD process, a variety of energy sources may be used to activate the precursor gas, including, but not limited to, one or more heated filaments or filament array(s), ionic plasma, pulsed plasma, UV irradiation, or gamma irradiation. In some instances, a voltage applied to heat filaments or filament arrays can be in a range of between about 40 to about 60 volts.

B. Plasma Enhanced Chemical Vapor Deposition (PECVD)

In some instances of the methods described, the ion-conductive polymer is deposited onto the inert support or electrode using a plasma enhanced chemical vapor deposition (PECVD). In some other instances of the methods described, the properties of an ion exchange membrane are modified by exposure to conditions of a plasma enhanced chemical vapor deposition (PECVD), where the conditions do not cause formation or deposition of any polymers or layers thereof (i.e., by exclusion of monomers or other reactive species which could form such polymers or layers during the exposure conditions). The skilled person would be able to exclude monomers from the PECVD conditions described below.

In certain embodiments, the plasma may be a phase of matter which may comprise particles which are charged and/or comprise a free radical. Without wishing to be bound by theory, the presence of plasma during polymerization may provide energy that aids in initiator and/or monomer fragmentation. In certain embodiments, the plasma may be provided in the form of a wave. In some embodiments, the plasma may be at a ratio frequency. According to certain embodiments, the plasma may be at a frequency of greater than or equal to 3 MHz, greater than or equal to 5 MHz, greater than or equal to 7.5 MHz, greater than or equal to 10 MHz, greater than or equal to 12.5 MHz, greater than or equal to 15 MHz, greater than or equal to 17.5 MHz, greater than or equal to 20 MHz, greater than or equal to 25 MHz, greater than or equal to 30 MHz, greater than or equal to 35 MHz, or greater than or equal to 40 MHz. In some embodiments, the plasma may be at a frequency of less than or equal to 50 MHz, less than or equal to 35 MHz, less than or equal to 30 MHz, less than or equal to 25 MHz, less than or equal to 20 MHz, less than or equal to 17.5 MHz, less than or equal to 15 MHz, less than or equal to 12.5 MHz, less than or equal to 10 MHz, less than or equal to 7.5 MHz, or less than or equal to 5 MHz. Combinations of the above-referenced ranges are also possible (e.g., greater than or equal to 7.5 MHz and less than or equal to 20 MHz, greater than or equal to 10 MHz and less than or equal to 15 MHz, or greater than or equal to 10 MHz and less than or equal to 20 MHz). Other ranges are also possible. In some embodiments, changes in plasma frequency may assist to provide uniform coating coverage over 3D substrates, such as porous supports or electrodes.

In certain embodiments, the plasma may be supplied in the form of one or more pulses. Pulses may occur at any frequency. In some embodiments, the plasma may be supplied in the form of pulses with a frequency of greater than or equal to 0.25 kHz, greater than or equal to 0.5 kHz, greater than or equal to 0.75 kHz, greater than or equal to 1 kHz, greater than or equal to 1.5 kHz, greater than or equal to 2 kHz, greater than or equal to 3 kHz, greater than or equal to 5 kHz, greater than or equal to 7.5 kHz, greater than or equal to 10 kHz, greater than or equal to 15 kHz, greater than or equal to 25 kHz, greater than or equal to 50 kHz, or greater than or equal to 75 kHz. In accordance with certain embodiments, the plasma may be supplied in the form of pulses with a frequency of less than or equal to 100 kHz, less than or equal to 75 kHz, less than or equal to 50 kHz, less than or equal to 25 kHz, less than or equal to 15 kHz, less than or equal to 10 kHz, less than or equal to 7.5 kHz, less than or equal to 5 kHz, less than or equal to 3 kHz, less than or equal to 2 kHz, less than or equal to 1.5 kHz, less than or equal to 1 kHz, less than or equal to 0.75 kHz, or less than or equal to 0.5 kHz. Combinations of the above-referenced ranges are also possible (e.g., greater than or equal to 0.5 kHz and less than or equal to 10 kHz, greater than or equal to 1 kHz and less than or equal to 15 kHz, or greater than or equal to 1 kHz and less than or equal to 10 kHz). Other ranges are also possible.

In accordance with some embodiments, the plasma may be supplied in the form of pulses which comprise a duty cycle. A duty cycle may be defined as the amount of time for which the plasma is applied divided by the total cycle time (the sum of the time for which the plasma is applied and the time for which the plasma is not applied). Any suitable duty cycle may be employed. According to certain embodiments, the plasma may be supplied in the form of pulses which comprise a duty cycle of greater than or equal to 0.02, greater than or equal to 0.05, greater than or equal to 0.1, greater than or equal to 0.2, greater than or equal to 0.3, greater than or equal to 0.4, or greater than or equal to 0.5. In some embodiments, the plasma may be supplied in the form of pulses which comprise a duty cycle of less than or equal to 0.75, less than or equal to 0.5, less than or equal to 0.4, less than or equal to 0.3, less than or equal to 0.2, less than or equal to 0.1, or less than or equal to 0.05. Combinations of the above—referenced ranges are also possible (e.g., greater than or equal to 0.05 and less than or equal to 0.2). Other ranges are also possible. In some embodiments, the plasma is supplied at a constant intensity throughout the polymerization.

In some embodiments, the plasma may be supplied from a plasma source, such as a plasma electrode (alternatively referred to as an active or powered electrode). A plasma may be applied to a substrate at any suitable distance from the substrate (ion exchange membrane), which can be located directly on or proximate to a ground electrode. In some instances, the substrate is not located directly on or proximate to the ground electrode but is located for example, in between the active electrode and the ground electrode. In certain embodiments, the substrate (i.e., porous support, electrode, silicon wafer, porous polymer support (e.g. PES), or another ion exchange membrane) can be placed at a distance (d) ranging from about 1 cm to 95 cm, 1 cm to 90 cm, 1 cm to 80 cm, 1 cm to 70 cm, 1 cm to 60 cm, 1 cm to 50 cm, 1 cm to 40 cm, or from about 10 cm to 50 cm or 10 cm to about 40 cm from the ground electrode, as well as sub-ranges within. For example, the substrate may be at a distance (d) from about 10 cm to about 15 cm, from about 10 cm to about 20 cm, from about 10 cm to about 30 cm, from about 15 cm to about 20 cm, from about 15 cm to about 30 cm, from about 20 cm to about 30 cm, or from about 30 cm to about 40 cm from the ground electrode. In certain embodiments, the substrate (i.e., sample) can be placed at a distance (d) ranging from about 1 cm to 95 cm, 1 cm to 90 cm, 1 cm to 80 cm, 1 cm to 70 cm, 1 cm to 60 cm, 1 cm to 50 cm, 1 cm to 40 cm, or from about 10 cm to 50 cm or 10 cm to about 40 cm from the plasma (powered or active) electrode, as well as sub-ranges within. For example, the substrate may be at a distance (d) from about 10 cm to about 15 cm, from about 10 cm to about 20 cm, from about 10 cm to about 30 cm, from about 15 cm to about 20 cm, from about 15 cm to about 30 cm, from about 20 cm to about 30 cm, or from about 30 cm to about 40 cm from the plasma (powered or active) electrode. In certain embodiments, the plasma may be supplied from a plasma (powered or active) electrode at a distance from the substrate and/or ground electrode of greater than or equal to 1 cm, greater than or equal to 3 cm, greater than or equal to 5 cm, greater than or equal to 8 cm, greater than or equal to 10 cm, greater than or equal to 15 cm, greater than or equal to 20 cm, greater than or equal to 25 cm, greater than or equal to 30 cm, greater than or equal to 40 cm, greater than or equal to 50 cm, greater than or equal to 60 cm, greater than or equal to 70 cm, greater than or equal to 80 cm, greater than or equal to 90 cm, or greater than or equal to 95 cm. In accordance with some embodiments, the plasma may be supplied from a plasma (powered or active) electrode at a distance from the substrate and/or ground electrode of less than or equal to 95 cm, less than or equal to 90 cm, less than or equal to 80 cm, less than or equal to 70 cm, less than or equal to 60 cm, less than or equal to 50 cm, less than or equal to 40 cm, less than or equal to 30 cm, less than or equal to 25 cm, less than or equal to 20 cm, less than or equal to 15 cm, less than or equal to 10 cm, less than or equal to 8 cm, less than or equal to 5 cm, or less than or equal to 3 cm. Combinations of the above-referenced ranges are also possible (e.g., greater than or equal to 1 cm and less than or equal to 30 cm, greater than or equal to 3 cm and less than or equal to 25 cm, or greater than or equal to 8 cm and less than or equal to 50 cm). Other ranges are also possible.

The plasma or active electrode may have a greatest dimension (e.g. length, width, or diameter) of about 0.1 cm, 0.5 cm, 1 cm, 5 cm, 10 cm, 15 cm, 20 cm, 25 cm, 30 cm, 35 cm, 40 cm, 45 cm, 50 cm, 55 cm, 60 cm, or greater. The plasma or active electrode may have an area in a range of between about 0.5-10000 cm², 0.5-9000 cm², 0.5-8000 cm², 0.5-7000 cm², cm², 0.5-5000 cm², 0.5-4000 cm², 0.5-3000 cm², 0.5-2000 cm², 1-10000 cm², 1-9000 cm², 1-8000 cm², 1-7000 cm², 1-6000 cm², 1-5000 cm², 1-4000 cm², 1-3000 cm², 1-2000 cm², 1-1500 cm², 1-1000 cm², 1-750 cm², 1-500 cm², 1-250 cm², 1-100 cm², 1-50 cm², 1-25 cm², or 1-10 cm². Other ranges are also possible. In some instances, the plasma or active electrode may have an area of about 10000 cm², 9500 cm², 9000 cm², 8500 cm², 8000 cm², 7500 cm², 7000 cm², 6500 cm², 6000 cm², 5500 cm², 5000 cm², 4500 cm², 4000 cm², 3500 cm², 3000 cm², 2500 cm², 2000 cm², 1900 cm², 1800 cm², 1700 cm², 1600 cm², 1500 cm², 1400 cm², 1300 cm², 1200 cm², 1100 cm², 1000 cm², 900 cm², 800 cm², 700 cm², 600 cm², 500 cm², 400 cm², 300 cm², 200 cm², or 100 cm².

The ground electrode may have a greatest dimension (e.g. length, width, or diameter) of about 0.1 cm, 0.5 cm, 1 cm, 5 cm, 10 cm, 15 cm, 20 cm, 25 cm, 30 cm, 35 cm, 40 cm, 45 cm, 50 cm, 55 cm, 60 cm, or greater. The ground electrode may have an area in a range of between about 0.5-10000 cm², 0.5-9000 cm², 0.5-8000 cm², 0.5-7000 cm², 0.5-6000 cm², 0.5-5000 cm², 0.5-4000 cm², 0.5-3000 cm², 0.5-2000 cm², 1-10000 cm², 1-9000 cm², 1-8000 cm², 1-7000 cm², 1-6000 cm², 1-5000 cm², 1-4000 cm², 1-3000 cm², 1-2000 cm², 1-1500 cm², 1-1000 cm², 1-750 cm², 1-500 cm², 1-250 cm², 1-100 cm², 1-50 cm², 1-25 cm², or 1-10 cm². Other ranges are also possible. In some instances, the ground electrode may have an area of about 10000 cm², 9500 cm², 9000 cm², 8500 cm², 8000 cm², 7500 cm², 7000 cm², 6500 cm², 6000 cm², 5500 cm², 5000 cm², 4500 cm², 4000 cm², 3500 cm², 3000 cm², 2500 cm², 2000 cm², 1900 cm², 1800 cm², 1700 cm², 1600 cm², 1500 cm², 1400 cm², 1300 cm², 1200 cm², 1100 cm², 1000 cm², 900 cm², 800 cm², 700 cm², 600 cm², 500 cm², 400 cm², 300 cm², 200 cm², or 100 cm².

In some instances, the plasma or active electrode and ground electrode have the same shape and same surface area.

The plasma may be supplied at any suitable power. The power may be in the range, for example, of between about 0.1 to 300 Watts, 0.1 to 275 Watts, 0.1 to 250 Watts, 0.1 to 200 Watts, 0.1 to 150 Watts, 0.1 to 100 Watts, 0.1 to 75 Watts, 0.1 to 50 Watts, 0.1 to 25 Watts, 0.1 to 10 Watts, or to 5 Watts. Other ranges are also possible. In some instances, the power may be about 10 Watts, 25 Watts, 50 Watts, 75 Watts, 100 Watts, 125 Watts, 150 Watts, 175 Watts, 200 Watts, 225 Watts, 250 Watts, 275 Watts, or 300 Watts.

The plasma may be provided at any suitable plasma power density. The plasma power density of a plasma may be defined as the energy provided by the plasma per square centimeter plasma RF electrode. In some embodiments, the plasma may be present at a plasma power density of greater than or equal to 0.1 mW/cm², greater than or equal to 0.25 mW/cm², greater than or equal to 0.5 mW/cm², greater than or equal to 0.75 mW/cm², greater than or equal to 1 mW/cm², greater than or equal to 1.5 mW/cm², greater than or equal to 2 mW/cm², greater than or equal to 5 mW/cm², greater than or equal to 7.5 mW/cm², greater than or equal to 10 mW/cm², greater than or equal to 12.5 mW/cm², greater than or equal to 15 mW/cm², greater than or equal to 20 mW/cm², greater than or equal to 30 mW/cm², greater than or equal to 35 mW/cm², greater than or equal to 40 mW/cm², greater than or equal to 45 mW/cm², or greater than or equal to 50 mW/cm². According to certain embodiments, the plasma may be present at a plasma power density of less than or equal to 50 mW/cm², less than or equal to 45 mW/cm², less than or equal to 40 mW/cm², less than or equal to 35 mW/cm², less than or equal to 30 mW/cm², less than or equal to 25 mW/cm², less than or equal to 20 mW/cm², less than or equal to 15 mW/cm², less than or equal to 12.5 mW/cm², less than or equal to 10 mW/cm², less than or equal to 7.5 mW/cm², less than or equal to 5 mW/cm², less than or equal to 2 mW/cm², less than or equal to 1.5 mW/cm², less than or equal to 1 mW/cm², less than or equal to 0.75 mW/cm², less than or equal to 0.5 mW/cm², less than or equal to 0.25 mW/cm², or less than or equal to 0.1 mW/cm². Combinations of the above-referenced ranges are also possible (e.g., greater than or equal to 0.5 mW/cm² and less than or equal to 1 mW/cm², greater than or equal to 0.5 mW/cm² and less than or equal to 2 mW/cm², greater than or equal to 0.75 mW/cm² and less than or equal to 5 mW/cm², greater than or equal to 1 mW/cm² and less than or equal to 10 mW/cm², or greater than or equal to 0.5 mW/cm² and less than or equal to 15 mW/cm²). Other ranges are also possible.

The plasma may be provided at any suitable volumetric plasma power density based on the distance from the ground electrode to the active electrode and the power densities of the plasma can be as described above. The volumetric plasma power density refers to the energy provided by the plasma per volume (e.g., cubic centimeters) of the region between the active electrode and ground electrode. The corresponding volumetric power densities for the distances and plasma power density ranges described above are provided in the following table.

TABLE 1

| | | 1 cm | 3 cm | 5 cm | 8 cm | 10 cm | 15 cm | 20 cm | 25 cm | 30 cm | 50 cm |
|---|---|---|---|---|---|---|---|---|---|---|---|
| 0.5 | mW/cm² | 0.50 | 0.17 | 0.10 | 0.06 | 0.05 | 0.03 | 0.03 | 0.02 | 0.02 | 0.01 |
| 0.75 | mW/cm² | 0.75 | 0.25 | 0.15 | 0.09 | 0.08 | 0.05 | 0.04 | 0.03 | 0.03 | 0.02 |
| 1 | mW/cm² | 1.00 | 0.33 | 0.20 | 0.13 | 0.10 | 0.07 | 0.05 | 0.04 | 0.03 | 0.02 |
| 1.5 | mW/cm² | 1.50 | 0.50 | 0.30 | 0.19 | 0.15 | 0.10 | 0.08 | 0.06 | 0.05 | 0.03 |
| 2 | mW/cm² | 2.00 | 0.67 | 0.40 | 0.25 | 0.20 | 0.13 | 0.10 | 0.08 | 0.07 | 0.04 |
| 5 | mW/cm² | 5.00 | 1.67 | 1.00 | 0.63 | 0.50 | 0.33 | 0.25 | 0.20 | 0.17 | 0.10 |
| 7.5 | mW/cm² | 7.50 | 2.50 | 1.50 | 0.94 | 0.75 | 0.50 | 0.38 | 0.30 | 0.25 | 0.15 |
| 10 | mW/cm² | 10.00 | 3.33 | 2.00 | 1.25 | 1.00 | 0.67 | 0.50 | 0.40 | 0.33 | 0.20 |
| 12.5 | mW/cm² | 12.50 | 4.17 | 2.50 | 1.56 | 1.25 | 0.83 | 0.63 | 0.50 | 0.42 | 0.25 |
| 15 | mW/cm² | 15.00 | 5.00 | 3.00 | 1.88 | 1.50 | 1.00 | 0.75 | 0.60 | 0.50 | 0.30 |
| 20 | mW/cm² | 20.00 | 6.67 | 4.00 | 2.50 | 2.00 | 1.33 | 1.00 | 0.80 | 0.67 | 0.40 |
| 30 | mW/cm² | 30.00 | 10.00 | 6.00 | 3.75 | 3.00 | 2.00 | 1.50 | 1.20 | 1.00 | 0.60 |
| 35 | mW/cm² | 35.00 | 11.67 | 7.00 | 4.38 | 3.50 | 2.33 | 1.75 | 1.40 | 1.17 | 0.70 |
| 40 | mW/cm² | 40.00 | 13.33 | 8.00 | 5.00 | 4.00 | 2.67 | 2.00 | 1.60 | 1.33 | 0.80 |
| 45 | mW/cm² | 45.00 | 15.00 | 9.00 | 5.63 | 4.50 | 3.00 | 2.25 | 1.80 | 1.50 | 0.90 |
| 50 | mW/cm² | 50.00 | 16.67 | 10.00 | 6.25 | 5.00 | 3.33 | 2.50 | 2.00 | 1.67 | 1.00 |

The non-bold values shown in Table 1 are volumetric plasma power densities (mW/cm³), which are obtained by dividing the power density value (left column; in bold) by the distance values from the substrate or ground electrode to the active electrode (top row; in bold). In some embodiments, the volumetric plasma power density during the plasma-enhanced chemical vapor deposition (PECVD) process is within any range based on values shown in Table 1, such as from about 0.01 mW/cm³ to about 100 mW/cm³, from about 0.01 mW/cm³ to about 50 mW/cm³, from about 0.01 mW/cm³ to about 25 mW/cm³, from about 0.01 mW/cm³ to 20 mW/cm³, from about 0.01 mW/cm³ to about 10 mW/cm³, from about 0.01 mW/cm³ to about 5 mW/cm³, or from about 0.01 mW/cm³ to about 2.5 mW/cm³. In yet other embodiments, the volumetric plasma power density can have a value in any suitable range, such as from about 0.001 mW/cm³ to about 100 mW/cm³, from about 0.001 mW/cm³ to about 50 mW/cm³, from about 0.001 mW/cm³ to about 25 mW/cm³, from about 0.001 mW/cm³ to about 20 mW/cm³, from about 0.001 mW/cm³ to about 10 mW/cm³, from about 0.001 mW/cm³ to about 5 mW/cm³, from about 0.001 mW/cm³ to about 2.5 mW/cm³, from about 0.001 mW/cm³ to about 1.5 mW/cm³, or from about 0.001 mW/cm³ to about 1.0 mW/cm³. Other ranges are also possible. Optionally, the volumetric power density during the plasma-enhanced chemical vapor deposition (PECVD) process is at least about 0.001 mW/cm³, at least about 0.01 mW/cm³, at least about 0.1 mW/cm³, at least about 1 mW/cm³, at least about 1.5 mW/cm³, at least about 2.0 mW/cm³, or at least about 2.5 mW/cm³. The volumetric power density can be less than about 5 mW/cm³, less than about 4 mW/cm³, less than about 3 mW/cm³, less than about 2 mW/cm³, less than about 1 mW/cm³, or less than about 0.01 mW/cm³.

In some embodiments, volumetric plasma power density may be calculated based on an average area, which is the average of the active electrode area and the ground electrode area. The average of the active electrode area and the ground electrode area can be multiplied by the distance between the active electrode and the ground electrode to provide a volumetric value. The volumetric plasma power density based on the average area can be calculated by dividing the plasma power by the resulting volumetric value. Alternatively, volumetric plasma power density may be calculated based on the active electrode area alone. The plasma or active electrode area multiplied by the distance between the electrode and the substrate gives a volumetric value. The volumetric plasma power density based solely on active electrode area can be calculated by dividing the plasma power by the resulting volumetric value. The volumetric plasma power density, either based on average area of the active electrode area and the ground electrode area or of the active electrode area alone, can range from about 0.01 mW/cm³ to about 100 mW/cm³, from about 0.01 mW/cm³ to about 50 mW/cm³, from about 0.01 mW/cm³ to about 25 mW/cm³, from about 0.01 mW/cm³ to about 20 mW/cm³, from about 0.01 mW/cm³ to about 10 mW/cm³, or from about 0.01 mW/cm³ to about 5 mW/cm³, or from about 0.3 to about 2.0 mW/cm³. In yet other embodiments, the volumetric plasma power density, either based on average area of the active electrode area and the ground electrode area or of the active electrode area alone, can range from about 0.001 mW/cm³ to about 100 mW/cm³, from about 0.001 mW/cm³ to about 50 mW/cm³, from about 0.001 mW/cm³ to about 25 mW/cm³, from about 0.001 mW/cm³ to about 20 mW/cm³, from about 0.001 mW/cm³ to about 10 mW/cm³, from about 0.001 mW/cm³ to about 5 mW/cm³, from about 0.001 mW/cm³ to about 2.5 mW/cm³, or from about 0.3 to about 2.0 mW/cm³. Other ranges are also possible. In some embodiments, the active electrode and ground electrode areas are equal, and the volumetric plasma power density, whether based on average area or plasma or active electrode area, is the same.

The CVD conditions described herein occur in a reaction chamber. In some embodiments, the reaction chamber may further comprise a reaction volume where polymerization occurs. According to certain embodiments, the plasma may be substantially uniform throughout a reaction volume within the reaction chamber. Plasma uniformity may be characterized by the ratio of the standard deviation of the power density over the reaction volume to the average power density over the reaction volume. In some embodiments, the ratio of the standard deviation of the power density over the chamber volume to the average power density over the chamber volume is less than or equal to 25%, less than or equal to 20%, less than or equal to 15%, less than or equal to 10%, or less than or equal to 5%. Other ranges are also possible.

V. Uses of Selectivity Modified Ion Exchange Membranes and Modified Ion Exchange Membranes

The selectivity modified ion exchange membranes and modified ion exchange membranes described above can be used in desalination methods, such as electrodialysis and capacitive deionization. Electrodialysis is used for brackish water desalination, boiler feedwater production, waste and process water treatment, demineralization of food products, table salt production, and acid and base recovery. Capacitive deionization is used for water softening and residential water deionization. Other desalination processes, such as ion concentration polarization may utilize selectivity modified ion exchange membranes.

The selectivity modified ion exchange membranes described herein can also be used for acid recovery or salt recovery by diffusion dialysis. Furthermore, selectivity modified ion exchange membranes have applications in fuel cells (hydrogen or methanol fuel cells), electrolyzers (such as hydrogen or CO₂ electrolyzer), batteries (such as lithium ion batteries) and redox flow batteries.

### EXAMPLES

### Example 1: Deposition of an Anion Exchange Polymer Using an Ex-Situ or In-Situ Quaternization Reaction

A copolymer of divinylbenzene (DVB) and vinylpryridine (VP) monomers was deposited by chemical vapor deposition (CVD) from a vapor mixture of DVB, VP, tert-butylperoxide (TBPO; as an initiator) and nitrogen (inert carrier). DVB was sourced from Sigma Aldrich 80% purity, VP from Sigma Aldrich 95%, and TBPO from Sigma Aldrich 98%. CVD conditions were: pressure 1800 mTorr; flow rate VP: 5.3 sccm; flow rate DVB: 0.7 sccm; flow rate TBPO: 1 sccm; flow rate nitrogen:6 sccm; and filament voltage:45 V.

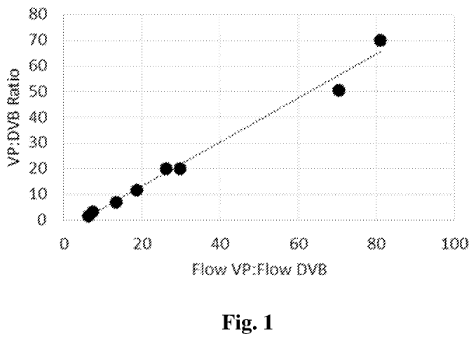

The composition of the copolymer formed was determined using Fourier transform infrared spectroscopy on a silicon substrate, which showed the incorporation of both DVB and VP monomers into the copolymer. It was found that the copolymer composition—expressed as the ratio of VP to DVB—could be controlled by controlling the ratio of flow rates of the DVB and VP monomer gasses. This was carried out on many different copolymers with VP:DVB ratios at between 1 and 10. See FIG. 1.

Accordingly, VP:DVB ratios between 0 and 10 were studied. The pressure of deposition was between 1200 and 3200 mTorr. The flow rates of VP were between 0 and 3 sccm and the flow rate of DVB was between 0 and 1 sccm. The total flow rate was between 1 and 10 sccm. The filament voltage was between 40 and 60 Volts.

A membrane was formed by deposition of copolymer on a support, which was a Fumasep FKS membrane from Fumatech BWT GmbH, then the vinylpyridine was converted to an ionic form by quaternization with methyl iodide (methyl iodide sourced from Sigma Aldrich 99.5%). For instance, the membrane was installed inside a sealed chamber at roughly atmospheric pressure, into which methyl iodide vapor was allowed to flow. The quaternization occurred spontaneously over the course of about 2 hours, though the reaction could be allowed to run for up to 24 hours. The quaternization was significantly accelerated in the presence of water vapor, which was introduced by adding a reservoir of liquid water into the chamber. The extent of quaternization was estimated using FTIR spectra with the peak at 1600 cm⁻¹ being indicative of the quaternized VP and the peak at 1640 cm¹ being indicative of the quaternized VP.

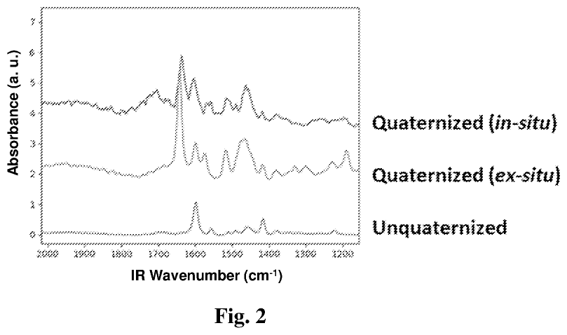

In another instance, quaternization was carried out simultaneously with film deposition by including a quaternizing agent, methyl iodide, during the process flow. Quaternization was confirmed by FTIR (see FIG. 2) spectroscopy. The partial pressure of methyl iodide was about 1920 mTorr.

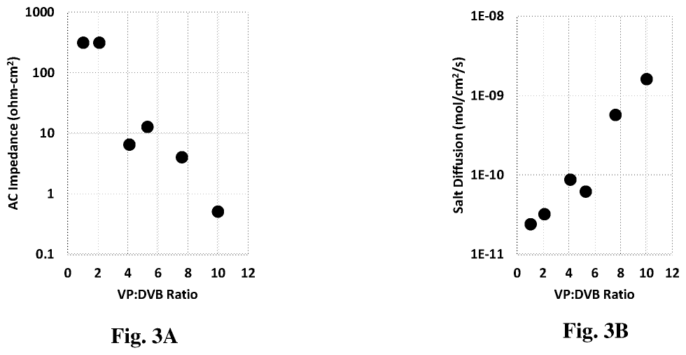

The key characteristics of the ion exchange polymer formed could be controlled via the polymer composition. For instance, the AC impedance and salt diffusion rates of copolymers with varying compositions, based on VP:DVB ratios, were measured. AC impedance was measured at 10 kHz in a solution of 1 M Na₂SO₄. The salt diffusion rate was measured as the rate of diffusion of NaCl across a membrane with a concentration gradient of 0.1 M. It was found that copolymers with low VP:DVB ratios had high AC impedance and low salt-diffusion crossover, while increasing VP:DVB ratios resulted in lower AC impedance and higher salt-diffusion crossover (see FIGS. 3A and 3B).

### Example 2: Deposition of a Cation Exchange Polymer with an In-Situ Sulfonation Reaction

A cation conductive polymer was deposited by chemical vapor deposition and performing an in-situ sulfonation reaction while depositing either a styrene polymer or a styrene and divinylbenzene (DVB) co-polymer. Chlorosulfonic acid (CSA) was used as a sulfonating reagent. DVB was sourced from Sigma Aldrich 80% purity, styrene was sourced from Sigma Aldrich 99%, TBPO was sourced from Sigma Aldrich 98%, and chlorosulfonic acid was sourced from Sigma Aldrich 99%. CVD conditions used were: pressure 900 mTorr; flow rate styrene: 0.2 sccm; flow rate CSA: 3 sccm; flow rate DVB: 1 sccm; flow rate TPBO: 1.5 sccm; flow rate nitrogen:2 sccm; and filament voltage:50 V.

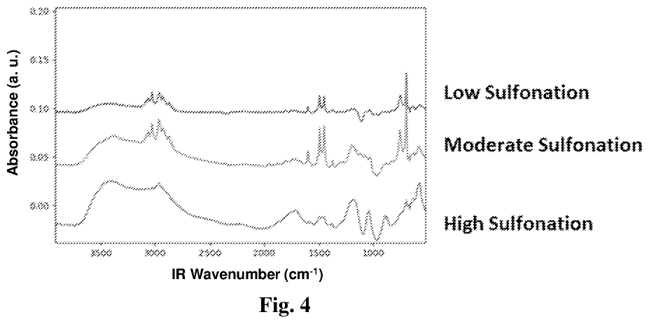

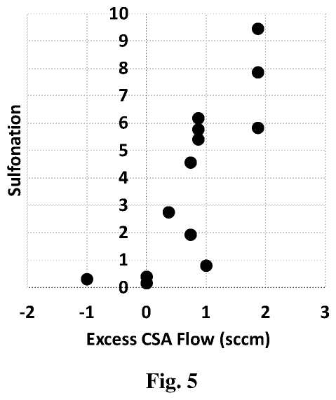

The styrene was converted to a styrene sulfonate, which may have taken place prior to polymerization on the surface of substrate, which was a Fumasep FAS membrane from Fumatech BWT GmbH, prior to polymerization in the gas phase or on the surface after/during polymerization. The flow rates of styrene monomer were between 0.13 and sccm, the flows of chlorosulfonic acid were between 1 and 4 sccm and the flow of DVB were between 0 and 0.13 sccm. The presence of styrene sulfonate groups was confirmed by FTIR and the extent of sulfonation was estimated by the relative areas of the peak around 1180 cm⁻¹ (S—O mode) and 700 cm⁻¹ (styrene ring mode) (see FIG. 4). A semi-quantitative sulfonation number was derived from the ratio of the areas of the two peaks. It was found for sulfonated styrene polymers that the relative flow of styrene and CSA was a variable which affected formation of a sulfonated polymer. Under conditions where the flow rate of CSA was greater than that of styrene monomer flow rate, a sulfonated polymer was achieved with the extent of sulfonation being roughly linearly dependent on the excess flow of CSA. Under conditions where the flow rates of CSA were lower than that of styrene monomer, only unsulfonated polystyrene was formed (see FIG. 5).

### Example 3: Enhancement of Monovalent Selectivity with an iCVD Treatment

The monovalent selectivity of a commercial cation exchange membrane (Fumasep FKS Membrane from Fumatech BWT GmbH, Germany) was increased by depositing by iCVD a thin layer of poly(divinylbenzene-co-vinylpyridine, a copolymer having a positively charged backbone to the surface of the membrane. CVD conditions used were: pressure 900 mTorr; flow rate styrene: 0.2 sccm; flow rate CSA: 3 sccm; flow rate DVB: 1 sccm; flow rate TPBO: 1.5 sccm; flow rate nitrogen:2 sccm; and filament voltage:50 V.

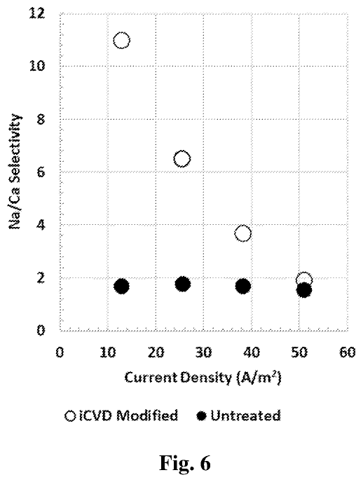

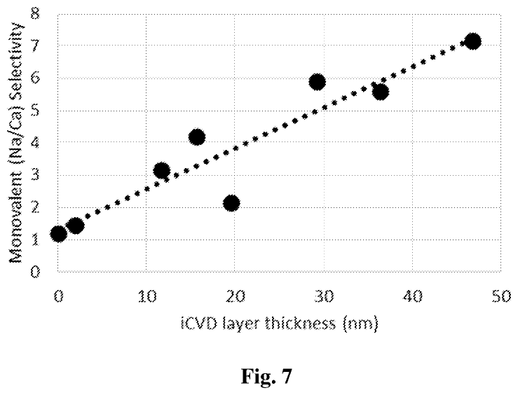

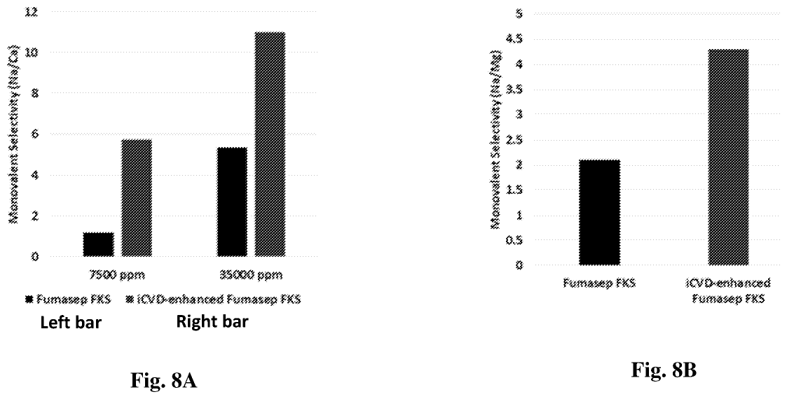

The thickness of the iCVD deposited copolymer was expected to be in the range of 10 to 50 nm. X-ray photoelectron spectroscopy (not shown) indicated the presence of the copolymer on the surface of the membrane. The selectivity of the modified membrane was measured by electrodialysis of a mixture of equimolar sodium chloride and calcium chloride with total dissolve solids content of 7,500 ppm at current densities between 12.7 and 50.9 A/m² for two hours. The mass of calcium and sodium chloride transported was determined by gravimetric and titrimetric analysis of the solutions after electrodialysis. The Na/Ca selectivity of a modified and untreated membrane is shown in FIG. 6 which indicates the monovalent selectivity (Na/Ca; y-axis) as a function of current density (A/m2; x-axis) of a membrane with and without an iCVD modification. The selectivity of the unmodified membrane did not change with increasing current density, whereas the selectivity of the modified membrane was highest at lower current densities. The Na/Ca selectivity was also found to increase with increasing thickness of the iCVD deposited copolymer layer up to around 50 nm, as shown in FIG. 7. The selectivity may further increase with thickness, where a tradeoff could arise between selectivity and conductivity. Or, a maximum in the selectivity may be reached after which point the selectivity would likely decrease. Lastly, as shown in FIGS. 8A and 8B, monovalent selectivity (Na/Ca and Na/Mg, respectively) of a Fumasep FKS membrane was found to increase by modification with an iCVD deposited copolymer layer.

While several instances or embodiments have been described and illustrated herein, those of ordinary skill in the art will readily envision a variety of other means and/or structures for performing the methods and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific instances or embodiments described herein. It is, therefore, to be understood that the foregoing instances or embodiments are presented by way of example only and that, within the scope of the appended claims and equivalents thereto, the invention may be practiced otherwise than as specifically described and claimed.

What is claimed is:

1. A method of depositing a selectivity modifying layer on an ion exchange membrane comprising the steps of:
(1) placing the ion exchange membrane into a reactor chamber;
(2) flowing a precursor gas in proximity to the ion exchange membrane, wherein the precursor gas comprises at least one monomer; and
(3) depositing the selectivity modifying layer on one or more surfaces of the ion exchange membrane by chemical vapor deposition (CVD) to form a selectivity modified ion exchange membrane,
wherein the selectivity modifying layer is optionally formed of or comprises an ion-conductive polymer.

2. The method of claim 1, wherein the chemical vapor deposition is initiated chemical vapor deposition (iCVD) or plasma-enhanced chemical vapor deposition (PECVD).

3. The method of claim 1, wherein the ion exchange membrane is a cation exchange membrane or an anion exchange membrane.

4. The method of claim 3, wherein the ion exchange membrane is a cation exchange membrane and the ion-conductive polymer of the selectivity modifying layer comprises cation or anion groups.

5. The method of claim 3, wherein the ion exchange membrane is an anion exchange membrane and the ion-conductive polymer of the selectivity modifying layer comprises anion or cation groups.

6. The method of claim 1, wherein the ion exchange membrane is a cation exchange membrane or an anion exchange membrane and the selectivity modifying layer is uncharged.

7. The method of claim 1, wherein the at least one monomer selected from the group consisting of divinylbenzene, styrene, styrene sulfonic acids, styrene sulfonates, methacrylic acid, vinyl pyridine, vinylamine, and vinylpyridinium salts.

8. The method of claim 1, wherein a chemical conversion is carried out during the depositing step on the at least one monomer before depositing and forming the selectivity modifying layer; or is carried out on the deposited and formed selectivity modifying layer during the depositing step; or is carried out on the deposited selectivity modifying layer following completion of step (3).

9. The method of claim 8, wherein the chemical conversion is sulfonation or methylation, phosphorylation, oxidation or reduction.

10. The method of claim 1, wherein the chemical vapor deposition is carried out at gas pressures from about 10 mTorr to about 10,000 mTorr or about 500 mTorr to about 4,000 mTorr and at gas flow rates from about 0.1-20 sccm.

11. The method of claim 1, wherein the precursor gas comprises an initiator.

12. The method of claim 1, wherein the selectivity modified ion exchange membrane after step (3) has a resistivity of less than about 1 ohm-cm² or less than about 0.5 ohm-cm²; the selectivity modified ion exchange membrane after step (3) has an ionic conductivity of between about 0.01 S/cm² to about 100 S/cm² or between about 1 S/cm² to about 100 S/cm²; and/or the selectivity modified ion exchange membrane after step (3) has a permselectivity of greater than about 90%.

13. A selectivity modified ion exchange membrane formed according to the method of claim 1.

14. A method of modifying one or more properties of an ion exchange membrane comprising the steps of:
(1′) placing the ion exchange membrane into a reactor chamber; and
(2′) exposing the ion exchange membrane to one or more conditions of a chemical vapor deposition (CVD) without deposition or formation of any additional layer on the ion exchange membrane,
wherein the ion exchange membrane after step (2′) is a modified ion exchange membrane.

15. The method of claim 14, wherein the one or more conditions are selected from:
(a) exposure to vacuum between about 10 mTorr and about 10 Torr;
optionally at a rate of depressurization of between about 1 Torr per minute to about 1000 Torr per minute;
(b) re-pressurization, optionally at a rate of about 1 Torr per minute to about 1000 Torr per minute;
(c) exposure to chemical conversion conditions, such as sulfonating or methylating reagents optionally at pressures of about 10 mTorr to about 10 Torr for times of about 5 seconds to about 60 minutes;
(d) exposure to heat from a filament that may bring the temperature of the surface of the ion exchange membrane to temperatures of between about 30° C. and about 150° C.;
(e) exposure to radio-frequency (RF) plasma at powers of about 5 W to about 300 W for periods of time of between about 1 second and about 10 minutes; and/or
(f) exposure to radical species, generated from initiators optionally at pressures of about 10 mTorr to about 10 Torr for periods of about 5 seconds to about 60 minutes.

16. The method of claim 14, wherein the ion exchange membrane is a cation exchange membrane or an anion exchange membrane.

17. The method of claim 14, wherein the one or more properties modified are selected from the permselectivity, conductivity, durability, and/or anti-fouling properties of the ion exchange membrane after step (2′), which are improved as compared to the properties of the ion exchange membrane before step (2′).

18. The method of claim 14, wherein the one or more conditions comprise the presence of a gas comprising an initiator.

19. The method of claim 14, wherein the modified ion exchange membrane after step (2′) has a resistivity of less than about 1 ohm-cm² or less than about 0.5 ohm-cm²; wherein the modified ion exchange membrane after step (2′) has an ionic conductivity of between about 0.01 S/cm² to about 100 S/cm² or between about 1 S/cm² to about 100 S/cm²; and/or wherein the modified ion exchange membrane after step (2′) has a permselectivity of greater than about 90%.

20. A modified ion exchange membrane formed according to the method of claim 14.
